(19) United States
(12) Patent Application Publication
(10) Pub. No.: US 2012/0313913 A1
(43) Pub. Date: Dec. 13, 2012

(54) DISPLAY DEVICE

(75) Inventors: Ichiroh Shiraki, Osaka (JP); Kazuhiro Maeda, Osaka (JP); Sachio Tsujino, Osaka (JP); Hiroaki Sugiyama, Osaka (JP); Yousuke Nakagawa, Osaka (JP)

(73) Assignee: SHARP KABUSHIKI KAISHA, Osaka (JP)

(21) Appl. No.: 13/581,208

(22) PCT Filed: Nov. 24, 2010
(86) PCT No.: PCT/JP2010/070896

§ 371 Date: Aug. 29, 2012

(30) Foreign Application Priority Data
Feb. 26, 2010 (JP) 2010-043097

(51) Int. Cl. G09G 5/00

(52) U.S. Cl. 345/207

(57) ABSTRACT

Detection signals of respective photo sensor circuits (senS, senD, senON, and senOFF) are activated so as to be output at once for each group of prescribed plural number of sensor rows (LSk) by a row driver (6). Within the prescribed number of sensor rows (LSk), photo sensor circuits (senS, senD, senON, and senOFF) sharing the same power line (SL2, SL5, . . . ) between at least two different sensor rows (LSk) are included. The detection signals of the respective photo sensor circuits (senS, senD, senON, and senOFF) in the prescribed number of sensor rows (senS, senD, senON, and senOFF) are output via mutually different output lines (SL1/SL3, SL4/SL6, . . . ).

### TECHNICAL FIELD

The present invention relates to a display device equipped with photosensors in a display area.

### BACKGROUND ART

A liquid crystal display device having photosensors in pixel circuits has been developed, and an application thereof to a fingerprint recognition and to a touch panel is sought after.

FIG. 17 shows a configuration of a display area provided in such a display device, which is described in Patent Document 1, and a circuit block that drives the display area.

In the display area, each of pixels 18 forming an array includes a sensor circuit 10 in addition to a display circuit made of a liquid crystal capacitance CLC, an auxiliary capacitance C2, a TFT M4, and the like. The sensor circuit 10 is equipped with an n-channel type amplifier TFT M1, a photo sensor D1, and a capacitance C1.

In the display circuit, the gate of the TFT M4 is connected to a gate line GL, and the source of the TFT M4 is connected to a data line 6′. The liquid crystal capacitance CLC is formed between a pixel electrode connected to the drain of the TFT M4 and a common electrode applied with a common voltage VCOM. The auxiliary capacitance C2 is formed between the pixel electrode and a common wiring line TFTCOM.

The gate line GL and the common wiring line TFTCOM are driven by a gate driver 15, and the data line 6′ is driven by a source driver 14.

In the sensor circuit 10, the cathode of the photo sensor D1 and one end of the capacitance C1 are connected to each other, and the gate of the amplifier TFT M1 is connected to a connecting point between the photo sensor D1 and the capacitance C1. The drain of the amplifier TFT M1 is connected to the data line 6′, and the source of the amplifier TFT M1 is connected to a sensor output wiring line 6. The data line 6′ is driven by a sensor read-out driver 17 through a not-shown switch during a sensor driving period that is different from a data signal writing period, and a voltage of the sensor output wiring line 6 is read out by the sensor read-out driver 17.

The anode of the photo sensor D1 is connected to a reset wiring line RST, and the other end of the capacitance C1 is connected to a row select wiring line RS. The reset wiring line RST and the row select wiring line RS are driven by a sensor row driver 16.

FIG. 18 shows a detailed circuit configuration to specifically construct the sensor circuit 10 described above. The drain of an amplifier TFT 21 (corresponding to the amplifier TFT M1 in FIG. 17) is connected to the data line 6′, and is applied with a voltage Vdd from the sensor read-out driver 17 during the sensor driving period. The source of the amplifier TFT 21 outputs a sensor output voltage Vout to the sensor output wiring line 6. The source of the amplifier TFT 21 is also connected to a fixed current source I that is separately provided in an IC or the like.

A photo sensor PD is made of a pin photodiode. The anode A of the photo sensor PD is applied with a voltage Vrs from the reset wiring line RST.

A terminal of a capacitance Cst (corresponding to the capacitance C1 in FIG. 17) that is opposite to a terminal connected to the gate of the amplifier TFT 21 is applied with a voltage Vrw from the row select wiring line RS.

A connecting point of the gate of the amplifier TFT 21, the cathode C of the photo sensor PD, and one end of the capacitance Cst is referred to as a node NetA.

Next, with reference to FIG. 19, an operation of the sensor circuit 10 configured in the manner described above will be explained.

During the sensor driving period, the data line 6′ is cut out from the source driver 14, and is connected to the sensor read-out driver 17. At a time t1 in the beginning of the sensor driving period, the sensor row driver 16 sets the voltage Vrs to a High level (0V, in this case), thereby outputting an initializing signal to the reset wiring line RST. This causes electricity to flow through the photo sensor PD in a forward direction, and as a result, a potential VnetA of the node NetA is set to a High level (0V, in this case). At this time, the voltage Vrw applied to the row select wiring line RS by the sensor row driver 16 is set to a Low level (0V, in this case). The voltage Vdd applied to the data line 6′ by the sensor read-out driver 17 is set to a DC voltage of 15V.

Next, at a time t2, the sensor row driver 16 sets the voltage Vrs to a Low level (−10V, in this case). At this time, the photo sensor PD turns to a reverse-biased state because the potential of the anode A becomes lower than that of the cathode C.

A charging period T1 starts from the time t2. During the charging period T1, the node NetA is charged in accordance with the intensity of light radiated to the photo sensor PD. When the light is radiated to the photo sensor PD, a leak current that flows from the cathode C toward the anode A is changed in accordance with the intensity of the illumination light. In a bright area, the leak current is large, and therefore, the potential of the anode A, hence the potential VnetA drops rapidly, and in a dark area, the leak current is small, and therefore, the potential VnetA drops gradually.

At a time t3 when the charging period T1 is completed, the sensor row driver 16 sets the voltage Vrw to a High level (20V, in this case), thereby outputting a read-out signal to the row select wiring line RS. As a result, the potential VnetA is boosted from a negative potential to a positive potential by a capacitance coupling with the capacitance Cst, and therefore, the potential difference between the bright area and the dark area is maintained. At this time, the amplifier TFT 21 is turned on, and an output period T2 for sensor output starts from the time t3.

A relationship between the total capacitance value Ctotal and the capacitance Cst of the sensor circuit is represented as follows:

α=Cst/Ctotal.

The size of the potential increase ΔVnetA of the potential VnetA by the voltage Vrw is defined by the following formula, where Vrwₚ₋ₚ is a peak-to-peak voltage of Vrw, which is 20V in the above-mentioned example:

ΔVnetA=α×Vrwₚ₋ₚ.

The output voltage Vout is determined in accordance with the potential VnetA, and is represented by the formula below, where Vth is a threshold voltage of the amplifier TFT 21, β is conductance of the amplifier TFT 21, and I is a current of the fixed current source I:

Vout≈VnetA−Vth−(2×I/β)^{1/2}.

Thus, by reading out the output voltage Vout by the sensor read-out driver 17 during the output period T2, the sensor output of the photo sensor PD, i.e., the intensity of the light radiated to the photo sensor PD, can be detected.

At a time t4 when the output period T2 is completed, the sensor row driver 16 sets the voltage Vrw to a Low level (0V, in this case), thereby completing the sensor driving period.

### RELATED ART DOCUMENTS

### Patent Documents

Patent Document 1: WO 2007/145347 (Publication date: Dec. 21, 2007)

Patent Document 2: Japanese Patent Application Laid-Open Publication No. H1-164165 (Publication date: Jun. 28, 1989)

Patent Document 3: Japanese Patent Application Laid-Open Publication No. 2007-47991 (Publication date: Feb. 22, 2007)

### SUMMARY OF THE INVENTION

### Problems to be Solved by the Invention

FIG. 20 shows an arrangement example of the sensor circuit.

The photo sensor PD is employed in the sensor circuit, and the output thereof includes a photocurrent component that is dependent on illumination light and a dark current component that is mainly dependent on a temperature. Therefore, even with the same illumination light intensity, the output values are varied under different temperatures, which does not allow for an accurate detection of the illumination light intensity. For this reason, by providing two types of circuits: photo detection circuits senS that perform detection and output of the illumination light; and dark current detection circuits senD that perform detection and output of the dark current, as sensor circuits, the detection output of the photo detection circuits senS is compensated by the detection output of the dark current detection circuits senD, which allows for the accurate detection of the illumination light intensity.

FIG. 21 shows a cross-sectional view of a panel, which includes a device configuration of the photo sensor PD.

On a transparent substrate 111 that becomes a TFT substrate, a light-shielding film 120, a semiconductor layer 112, an insulating film 113, metal wiring lines 114 and 114′, a planarizing film 115, a transparent electrode 116, a liquid crystal layer 117, a transparent electrode 118, and an opposite substrate 119 are laminated in this order. The semiconductor layer 112 that constitutes a pin photodiode has a P⁺ region, an I region, and an N⁺ region that are made of Si. The metal wiring line 114 as the anode electrode makes contact with the P⁺ region through a contact hole formed in the insulating film 113, and the metal wiring line 114′ as the cathode electrode makes contact with the N⁺ region through a contact hole formed in the insulating film 113.

As shown in FIG. 22, in the dark current detection circuit senD, a light-shielding film 121 that blocks light for detecting the dark current of the pin photodiode is provided on the side of the opposite substrate 119. A difference in the configuration between the dark current detection circuit senD and the photo detection circuit senS is presence or absence of this light-shielding film 121.

The dark current detection circuit senD needs to perform a reference output for the photo detection circuit senS, and therefore, the photo detection circuit senS and the dark current detection circuit senD that constitute a pair that performs the output compensation are arranged close to each other, and as shown in FIG. 20, the photo detection circuits senS and the dark current detection circuits senD that respectively form pairs in the column direction are arranged adjacent to each other, for example. One of the photo detection circuit senS and the dark current detection circuit senD is disposed in each region that includes a prescribed number of picture elements, i.e., a pixel that includes three picture elements of RGB, for example. One photo detection circuit senS is provided in a first pixel PIX1, and one dark current detection circuit senD is provided in a second pixel PIX2, respectively.

Because these photo detection circuits senS and dark current detection circuits senD lower the aperture ratio of the display area for display, these circuits are generally arranged with prescribed space therebetween on the display area, and normal pixels PIX0 that do not include the sensor circuits are inserted into the space between the photo detection circuits senS and the dark current detection circuits senD, respectively. However, the normal pixel PIX0 may be provided with a second photo detection circuit and a second dark current detection circuit that at least have photodiodes so as to improve the sensitivity to illumination light.

The sensor row driver 16 that is constituted of shift registers performs a reset operation and a read-out operation for the pairs of photo detection circuits senS and the dark current detection circuits senD line-sequentially, and the respective detection outputs are read out in two successive periods.

FIG. 23 shows a configuration of the shift registers of the sensor row driver 16, and FIG. 24 shows a timing chart for illustrating an operation of the shift registers.

The shift registers has two systems: a first system constituted of shift register stages 1W, 2W . . . that generate and output read-out signals; and a second system constituted of shift register stages 1S, 2S . . . that generate and output reset signals, and the respective systems perform shift operations based on a clock signal RCK. In the first system, a start pulse RWSP is shifted, and by shift outputs SRO1, SRO2 . . . that are sequentially output from the shift register stages 1W, 2W . . . , switches AW1, AW2 . . . are sequentially turned on, which causes High read-out signals RW to be sequentially output to read-out signal supply wiring lines as read-out signals RW1, RW2 . . . . In the second system, a start pulse RSSP is shifted, and by shift outputs that are sequentially output from the shift register stages 15, 2S . . . , switches AS1, AS2 . . . are sequentially turned on, which causes High reset signals RS to be sequentially output to reset signal supply wiring lines as reset signals RS1, RS2 . . . .

The read-out signals RW1, RW2 . . . are output in a period different from a display select period of the picture elements, and the reset signals RS1, RS2 . . . are output one frame period prior to the read-out operation.

However, in the conventional display device equipped with the sensor circuits described above, the respective detection outputs of a pair of the photo detection circuit senS and the dark current detection circuit senD are obtained in mutually different periods by the sequential scanning, which causes the photo detection output and the dark current detection output that are used for the compensation to have variations due to the time lag. For this reason, it is preferable that the light intensity to be detected be compensated by using reference photodiodes that are in the same environment. However, in the conventional display device, it is likely that an environment in which the dark current was detected by the dark current detection circuit senD differs from an environment in which the photo detection was performed by the photo detection circuit senS, resulting in a problem of not allowing for an accurate compensation in the photo detection.

The present invention was made in view of the above-mentioned problem in the conventional configuration, and is aiming at achieving a display device equipped with photo sensor circuits capable of accurately correcting the photo detection results, which includes an accurate compensation for the photo detection, by combining different types of data.

### Means for Solving the Problems

In order to solve the above-mentioned problem, a display device according to the present invention includes: a display area in which a plurality of picture element are arranged in a matrix; a plurality of sensor rows, output wiring lines, and power supply wiring lines that are arranged in the display area, the plurality of sensor rows being provided with photo sensor circuits that respectively output detection signals in accordance with illumination light intensity from output amplifiers thereof, the output wiring lines receiving the detection signals, the power supply wiring lines supplying power to the output amplifiers; and a row driver that drives the respective photo sensor circuits, wherein the row driver drives the respective photo sensor circuits such that the detection signals are output at once for each group of prescribed plural number of the sensor rows, wherein, in the prescribed number of the sensor rows, the photo sensor circuits of at least two different rows of the sensor rows share the same power supply wiring line, and wherein the detection signals of the photo sensor circuits in the prescribed number of the sensor rows are output through the output wiring lines that are mutually different.

According to the above-mentioned invention, by the row driver, outputs of detection signals from all of the photo sensor circuits included in the prescribed number of the sensor rows can be obtained at once through different sensor output wiring lines. This makes it possible, in detecting light intensity, to compensate the outputs of the photo sensor circuits with the outputs of the detection signals that were obtained at the same time from the other photo sensor circuits.

As described above, according to the above-mentioned invention, by driving the respective sensor rows in the prescribed number of pairs of sensor rows at once, and by reading out the detection outputs of the photo sensor circuits from these sensor rows at once, a plurality of pieces of data having smaller variations caused by the time lag among the respective sensor rows can be obtained. Further, by averaging the detection outputs that were simultaneously read out from the plurality of photo sensor circuits having the mutually same configuration, data with even smaller variations can be obtained.

By mutually combining the plurality of pieces of data obtained in the manner described above, it becomes possible to accurately correct one piece of data with the other piece of data, which includes an accurate compensation of the photo detection results with the dark current detection results.

As described above, it is possible to achieve an effect of providing a display device equipped with photo sensor circuits capable of accurately correcting the photo detection results, which includes an accurate compensation for the photo detection, by combining different types of data.

Because the photo sensor circuits in at least two different rows of the sensor rows share the same power supply wiring line, the number of wiring lines can be reduced, resulting in an effect of efficiently allocating the display area to the picture elements and the sensor circuits. Further, by sharing the power supply wiring lines, the output amplifiers in the photo sensor circuits can be arranged such that the output amplifiers of the photo sensor circuits that share the same power supply wiring line are located in proximity of the power supply wiring line in a concentrated manner. This makes it easier to avoid the interference in placing the power supply wiring lines for the plurality of pairs of photo sensor circuits that share the same power supply wiring line, resulting in an effect of significantly increasing the number of sensor rows having the photo sensor circuits that can be read out at once.

### Effects of the Invention

As described above, the display device according to the present invention includes: a display area in which a plurality of picture elements are arranged in a matrix; a plurality of sensor rows, output wiring lines, and power supply wiring lines that are arranged in the display area, the plurality of sensor rows being provided with photo sensor circuits that respectively output detection signals in accordance with illumination light intensity from output amplifiers thereof, the output wiring lines receiving the detection signals, the power supply wiring lines supplying power to the output amplifiers; and a row driver that drives the respective photo sensor circuits, wherein the row driver drives the respective photo sensor circuits such that the detection signals are output at once for each group of prescribed plural number of the sensor rows, wherein, in the prescribed number of the sensor rows, the photo sensor circuits of at least two different rows of sensor rows share the same power supply wiring line, and wherein the detection signals of the photo sensor circuits in the prescribed number of the sensor rows are output through the output wiring lines that are mutually different.

With this configuration, it is possible to achieve an effect of providing a display device equipped with photo sensor circuits capable of accurately correcting the photo detection results, which includes an accurate compensation for the photo detection, by combining the different types of data.

Because the photo sensor circuits of at least two different rows of the above-mentioned sensor rows share the same power supply wiring line, the number of wiring lines can be reduced, resulting in an effect of efficiently allocating the display area to the picture elements and the photo sensor circuits. Further, by sharing the power supply wiring lines, the output amplifiers in the photo sensor circuits can be arranged such that the output amplifiers of the photo sensor circuits that share the same power supply wiring line are located in proximity of the power supply wiring line in a concentrated manner. This makes it easier to avoid the interference in placing the power supply wiring lines for the plurality of pairs of photo sensor circuits that share the same power supply wiring line, resulting in an effect of significantly increasing the number of sensor rows having the photo sensor circuits that can be read out at once.

### BRIEF DESCRIPTION OF THE DRAWINGS

FIG. 1 is a figure illustrating an embodiment of the present invention, and shows an arrangement of picture elements and photo sensor circuits of a display device in a display area.

FIG. 2 is a circuit diagram illustrating a circuit configuration of picture elements, photo sensor circuits, and a row driver included in the display device shown in FIG. 1.

FIG. 3 is a circuit diagram illustrating another configuration of the photo sensor circuit of FIG. 2.

FIG. 4 is a figure illustrating an embodiment of the present invention, and is a block chart showing a fundamental configuration of the photo sensor circuit shown in FIG. 2.

FIG. 5 is a timing chart for illustrating an operation of the display device shown in FIG. 1.

FIG. 6 is a figure illustrating an embodiment of the present invention, and is an explanatory diagram for detection of internal signal light based on ambient light and internal signal light.

FIG. 7 is a diagram illustrating an embodiment of the present invention, and shows another example of an arrangement of the picture elements and the photo sensor circuits of the display device in the display area.

FIG. 8 is a diagram illustrating an embodiment of the present invention, and shows yet another example of an arrangement of the picture elements and the photo sensor circuits of the display device in the display area.

FIG. 9 is a circuit diagram showing a configuration example of the photo sensor circuit shown in FIGS. 7 and 8.

FIG. 10 is a figure illustrating an embodiment of the present invention, and shows a basic arrangement of the picture elements and the photo sensor circuits of the display device in the display area.

FIG. 11 is a circuit diagram showing a circuit configuration of picture elements, photo sensor circuits, and a row driver of the display device shown in FIG. 10.

FIG. 12 is a timing chart for illustrating an operation of the display device shown in FIG. 11.

FIG. 13 is a figure illustrating an embodiment of the present invention, and is a block chart showing a fundamental configuration of the photo sensor circuit shown in FIG. 11.

FIG. 14 is a timing chart showing an operation of the photo sensor circuit shown in FIG. 13.

FIG. 15 is a figure illustrating an embodiment of the present invention, and is a cross-sectional view showing a configuration of a photo sensor circuit.

FIG. 16 is a figure illustrating an embodiment of the present invention, and is a block diagram showing a configuration of a display device.

FIG. 17 is a figure illustrating a conventional technology, and is a circuit block diagram showing a configuration of a display device equipped with photo sensors.

FIG. 18 is a figure illustrating a conventional technology, and is a circuit diagram showing a configuration of a photo sensor circuit.

FIG. 19 is a timing chart showing an operation of the photo sensor circuit shown in FIG. 18.

FIG. 20 is a figure illustrating a conventional technology, and is a block diagram showing an arrangement pattern of photo sensor circuits.

FIG. 21 is a figure illustrating a conventional technology, and is a cross-sectional view showing a configuration of a photo sensor for photo detection.

FIG. 22 is a figure illustrating a conventional technology, and is a cross-sectional view showing a configuration of a photo sensor for dark current detection.

FIG. 23 is a figure illustrating a conventional technology, and is a block diagram showing a configuration of a sensor row driver.

FIG. 24 is a timing chart showing a configuration of the sensor row driver shown in FIG. 23.

### DETAILED DESCRIPTION OF EMBODIMENTS

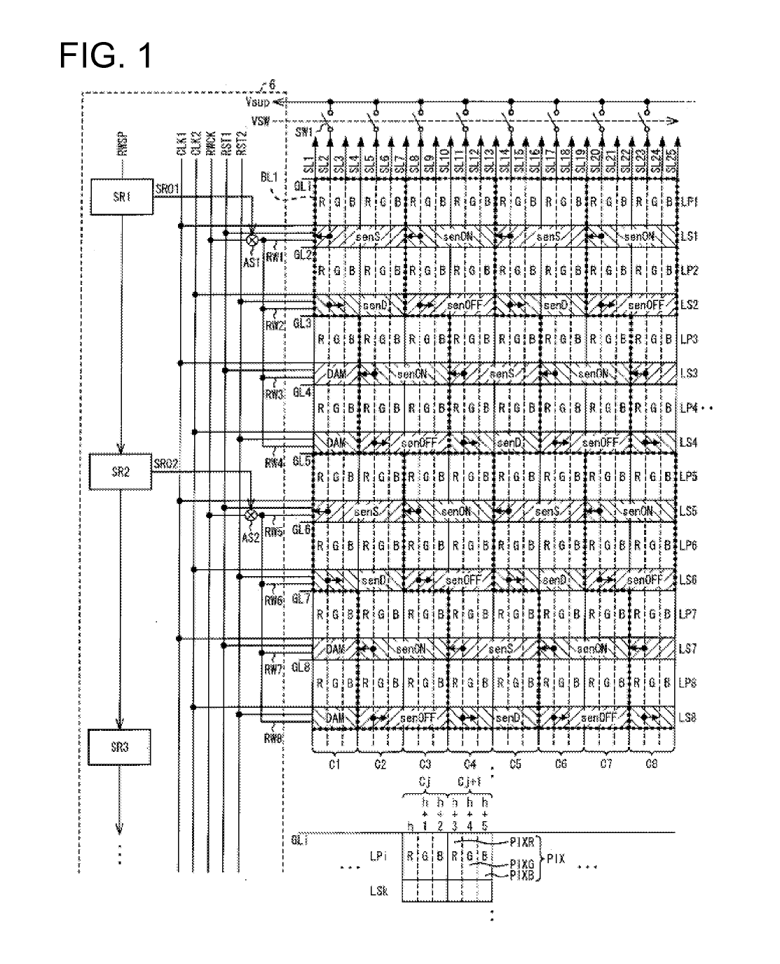

Below, an embodiment of the present invention will be explained with reference to FIGS. 1 to 16.

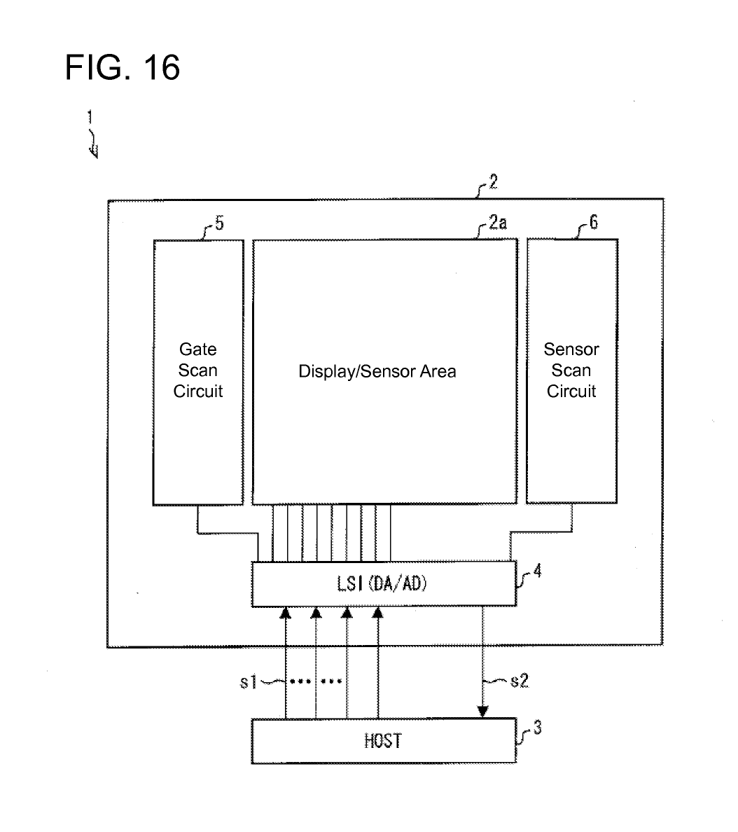

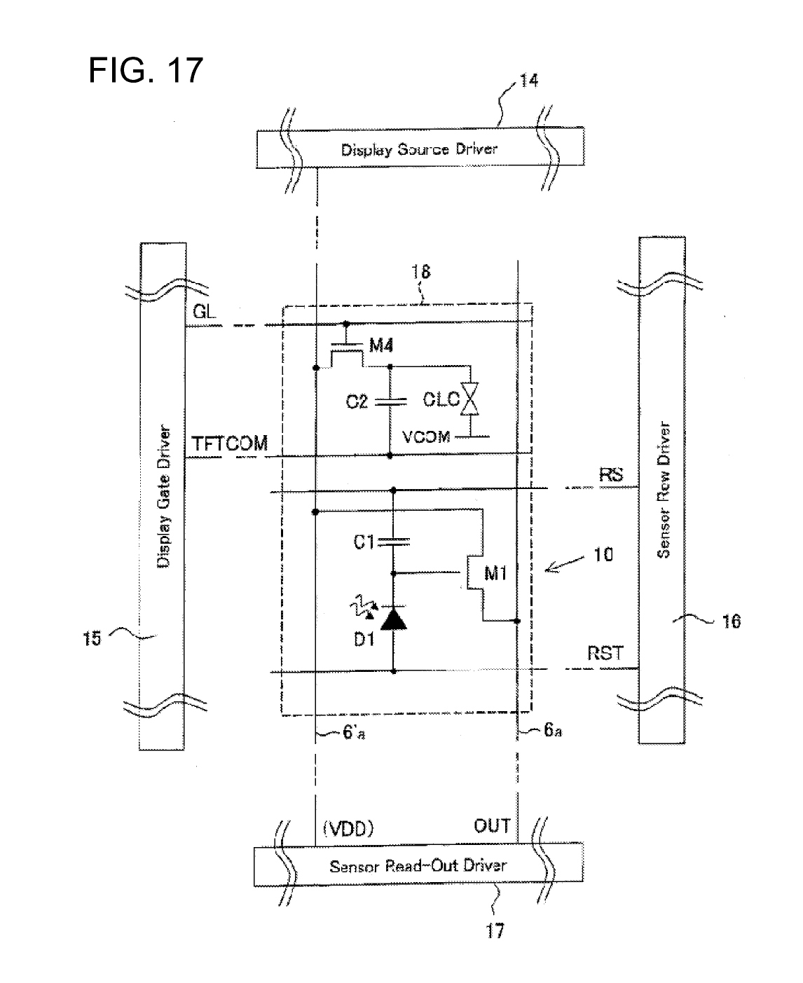

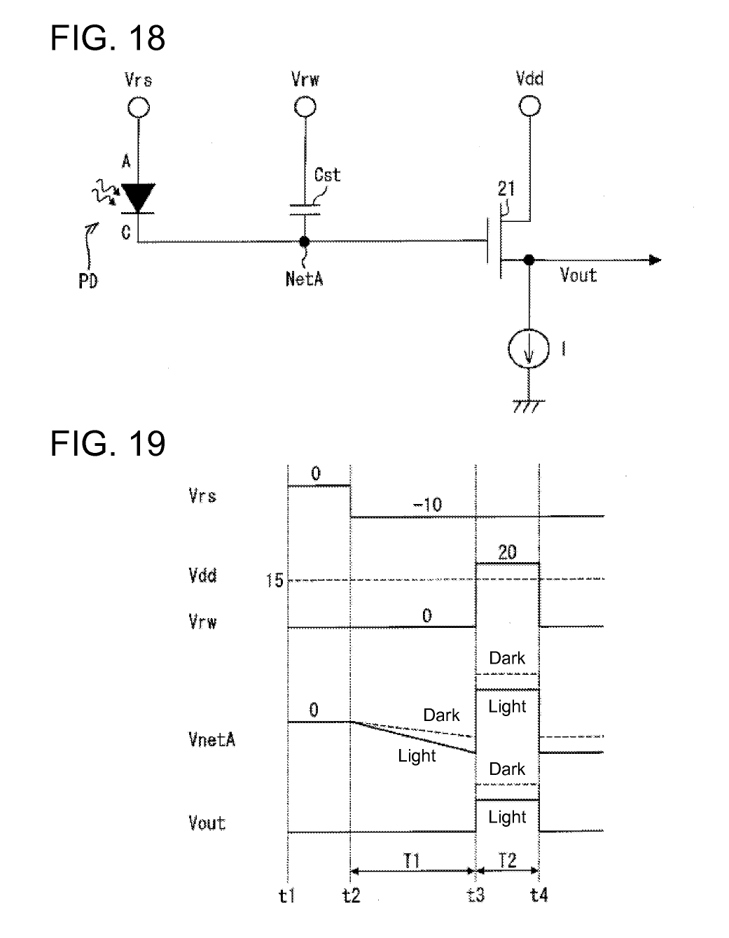

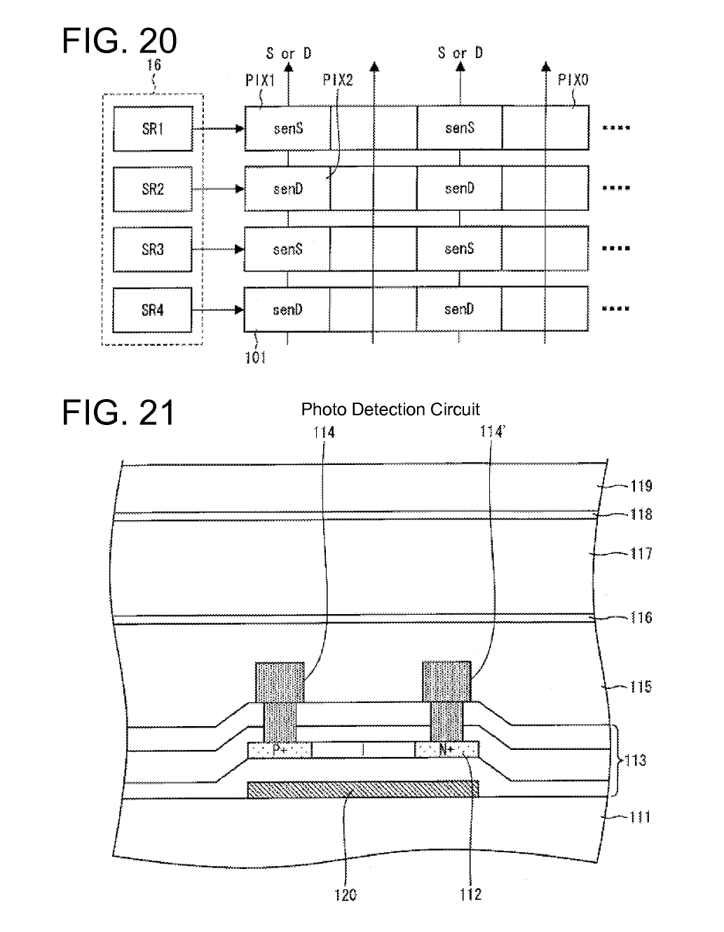

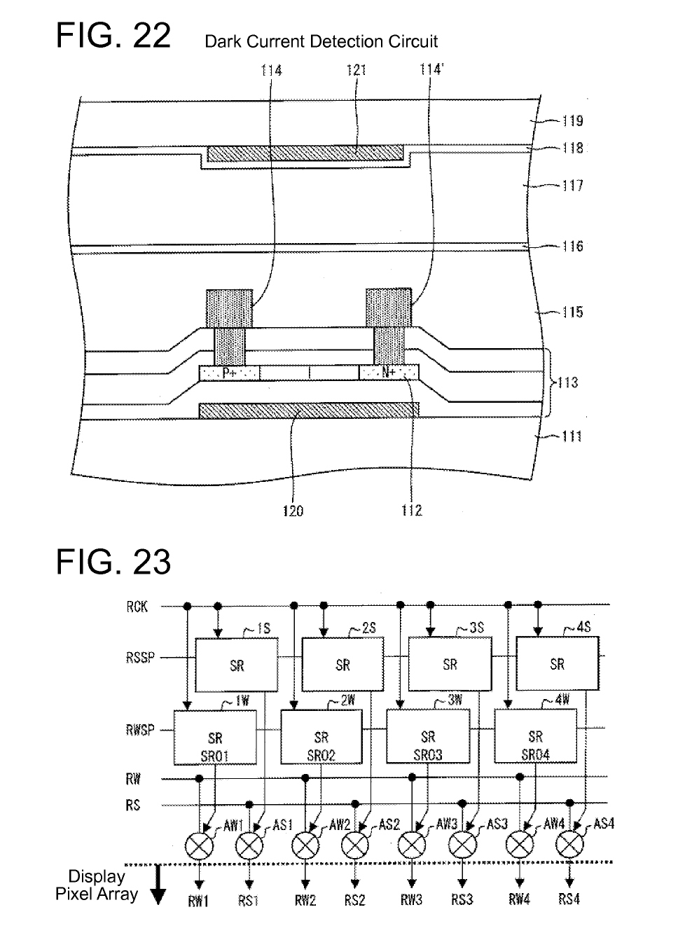

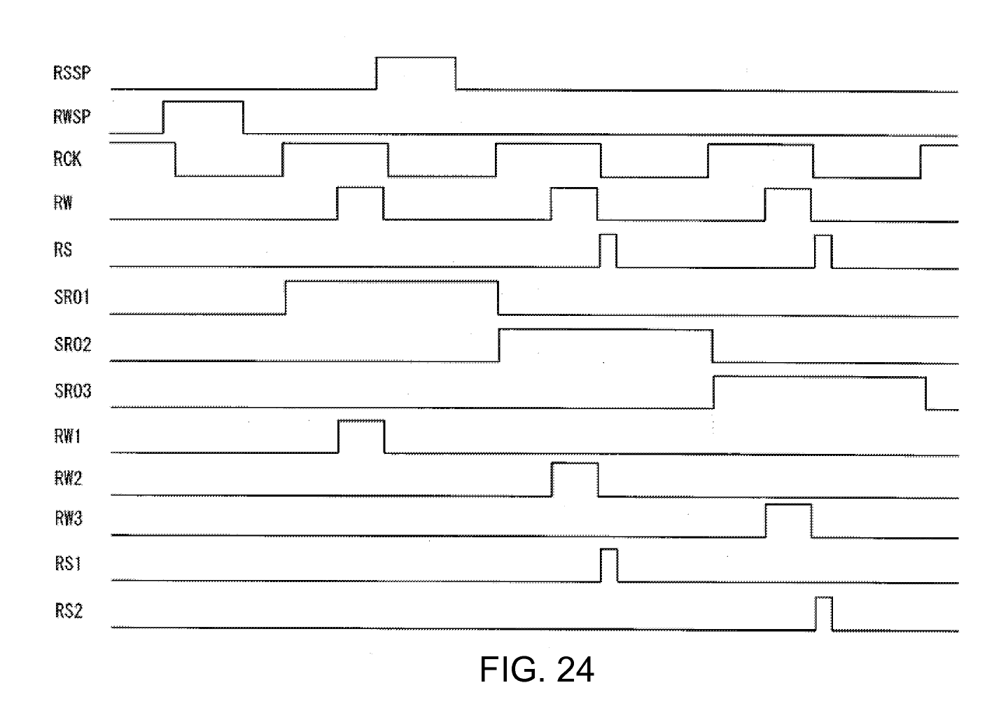

FIG. 16 shows a configuration of a liquid crystal display device 1 (display device) according to the present embodiment.

The liquid crystal display device 1 is an active matrix type display device, and includes a display panel 2 and a host controller 3.

The display panel 2 includes a display/sensor area 2a, a source driver 4 (data signal line driver circuit), a gate scan circuit 5 (scan signal line driver circuit), and a sensor scan circuit (row driver) 6. The display/sensor area (display area) 2a is an area of the display panel 2 in which one or more picture elements made of amorphous silicon, polysilicon, CG (Continuous Grain) silicon, microcrystalline silicon, or the like are arranged in a matrix, and includes the picture elements and photo sensor circuits arranged in a matrix as described below. The source driver 4 is an LSI chip that is directly mounted on the display panel 2, and has a configuration of so-called COG (Chip On Glass). The source driver 4 outputs data signals for picture elements to data signal lines in the display/sensor area 2a, and processes outputs from the photo sensor circuits. The gate scan circuit 5 outputs to gate lines (scan signal lines) a scan signal that is used to write the data signals into the picture elements in the display/sensor area 2a. The sensor scan circuit 6 supplies a required voltage to the photo sensor circuits in the respective sensor rows provided in the display/sensor area 2a, thereby respectively driving the photo sensor circuits sensor row by sensor row. Although it is shown in FIG. 16 that specific arrangement positions with respect to the display/sensor area 2a are given to the source driver 4, the gate scan circuit 5, and the sensor scan circuit 6, respectively, the arrangement of these components is not limited to such. They may be placed in any locations as long as the source driver 4 is provided as a driver that drives columns, and the gate scan circuit 5 and the sensor scan circuit 6 are provided as drivers that drive rows. The sensor scan circuit 6 may also be formed integrally with the gate scan circuit 5.

The host controller 3 is a control board that is provided outside the display panel 2, and supplies, to the source driver 4, display data to be provided to the source driver 4, a clock signal, a start pulse, and the like to be provided to the gate scan circuit 5, and a clock signal, a start pulse, a power supply voltage, and the like to be provided to the sensor scan circuit 6. FIG. 16 shows a configuration in which these supply signals and supply voltages are supplied to the gate scan circuit 5 and the sensor scan circuit 6 through the source driver 4 as an example.

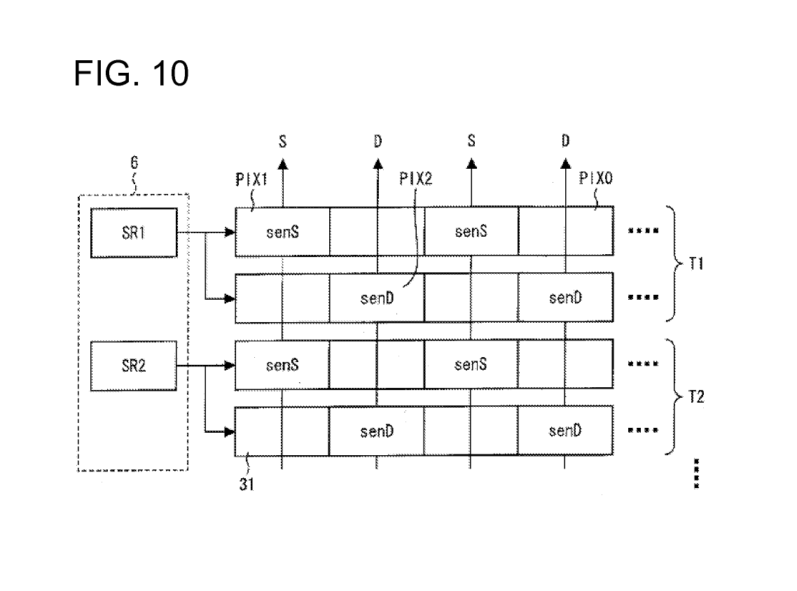

Next, FIG. 10 shows an arrangement example of the photo sensor circuits in the display/sensor area 2a.

As the photo sensor circuits, two types of circuits: photo detection circuits senS that perform detection and output of the illumination light; and dark current detection circuits senD that perform detection and output of the dark current, are provided, and by compensating the detection output of the photo detection circuits senS with the detection output of the dark current detection circuits senD, the accurate detection of the illumination light intensity is performed.

The photo detection circuit senS constitutes a first pixel PIX1 together with a display pixel made of three picture elements of RGB, for example. The dark current detection circuit senD constitutes a second pixel PIX2 together with a display pixel made of three picture elements of RGB, for example. In addition, a normal pixel PIX0 that only includes a display pixel made of three picture elements of RGB, for example, is provided.

One pixel row 31 includes the first pixels PIX1 and the normal pixels PIX0 arranged alternately in the row direction, and another pixel row 31 adjacent thereto includes the normal pixels PIX0 and the second pixels PIX2 arranged alternately in the row direction, and the respective two adjacent pixel rows 31 form pairs of pixel rows T1, T2 . . . . In the respective pairs of pixel rows, the photo detection circuits senS and the dark current detection circuits senD are respectively connected to different output lines for detection signals. In FIG. 10, the photo detection circuits senS are connected to sensor output wiring lines S, and the dark current detection circuits senD are connected to sensor output wiring lines D, respectively. Here, instead of using special wiring lines, the data signal lines can be used as the sensor output wiring lines S and D.

All of the photo detection circuits senS and the dark current detection circuits senD included in one pair of pixel rows are driven at once by corresponding one of scan shift register stages SR1, SR2 . . . provided in the sensor scan circuit 6. Therefore, in one pair of pixel rows, detection signals of the photo detection circuits senS and detection signals of the dark current detection circuits senD are sent to the source driver 4 at once. The respective pairs of pixel rows are driven by the sensor scan circuit 6 line-sequentially. The display pixels are driven by the gate scan circuit 5 line-sequentially, and when the data signal lines are used as the sensor output wiring lines S and D of the photo detection circuits senS and the dark current detection circuits senD, the detection signals are output to the sensor output wiring lines S and D during a period different from the period in which data signals are written in the display pixels.

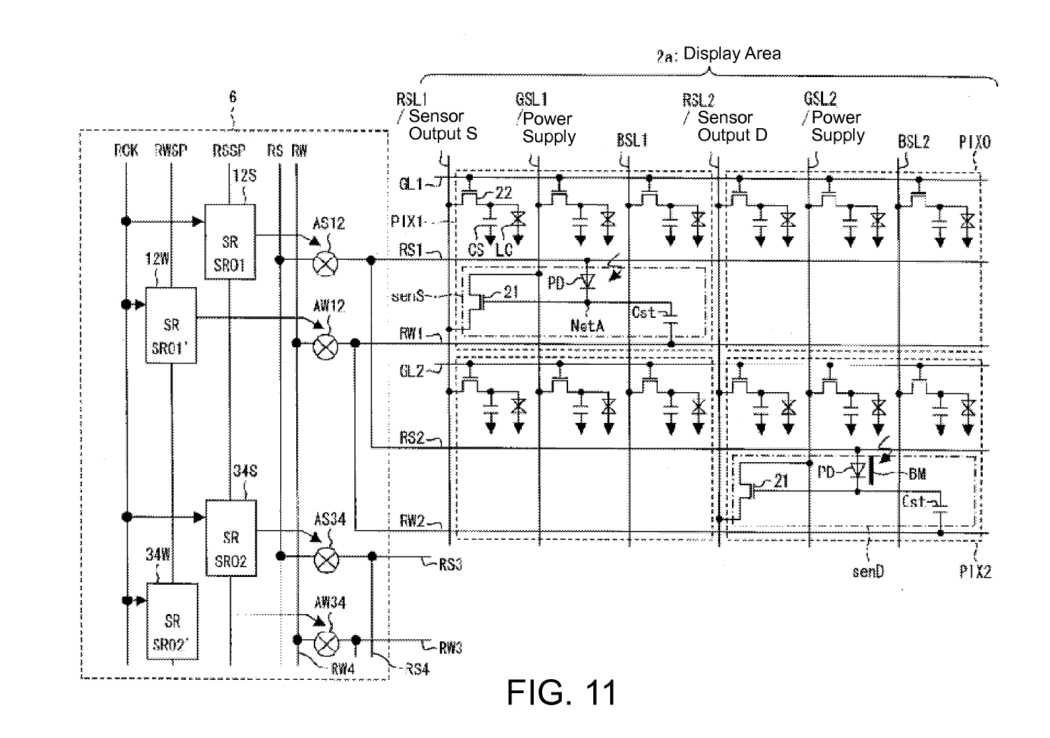

Next, FIG. 11 shows a detailed configuration of the first pixels PIX1, the second pixels PIX2, the normal pixels PIX0, and the sensor scan circuit 6.

Each of the display pixels included in the first pixels PIX1, the second pixels PIX2, and the normal pixels PIX0 is made of three picture elements of RGB, which are the same in each pixel. Each picture element includes a TFT 22, a liquid crystal capacitance LC, and an auxiliary capacitance CS. The TFT 22 is a select element for the picture element, and is an n-channel type here, for example. The source of the TFT 22 of an R picture element is connected to an R data signal line RSL(j), the source of the TFT 22 of a G picture element is connected to a G data signal line GSL(j), and the source of the TFT 22 of a B picture element is connected to a B data signal line BSL(j), respectively. Here, “j” is an integer of 1 or greater that represents the column number of the display pixel. ( ) is a writing expression used for convenience to indicate that a letter therein is a variable number, and is used for variable numbers of “h,” “i,” “j,” and “k,” including the descriptions below. The drain of the TFT 22, a picture element electrode, which is one end of the liquid crystal capacitance CL, and one end of the auxiliary capacitance CS are connected to each other.

The photo detection circuit senS includes a TFT (output amplifier) 21, a photo sensor PD, and a storage capacitance Cst. The TFT 21 is an n-channel type, for example, and the drain of the TFT 21 is connected to the data signal line GSL(j), and the source of the TFT 21 is connected to the data signal line RSL(j), respectively. The gate of the TFT 21 is connected to a node NetA, which is one end of the storage capacitance Cst. The photo sensor PD is made of a photodiode in this case, for example. The anode of the photo sensor PD is connected to the reset wiring line RS(i), and the cathode of the photo sensor PD is connected to the node NetA, respectively. The other end of the storage capacitance Cst is connected to the read-out wiring line RW(i). Here, “i” is an integer of 1 or greater that represents the row number of the display pixel and the photo sensor circuit.

For the photo detection circuit senS, the data signal line GSL(j) serves as a power supply wiring line for the TFT 21, and the data signal line RSL(j) serves as the sensor output wiring line S.

The dark current detection circuit senD includes the TFT (output amplifier) 21, the photodiode (photo sensor) PD, and the storage capacitance Cst, which are connected to each other in the same manner as those of the photo detection circuit senS. The dark current detection circuit senD includes a light-shielding film BM that blocks light from entering the photo sensor PD.

For the dark current detection circuit senD, the data signal line GSL(j) serves as a power supply wiring line of the TFT 21, and the data signal line RSL(j) serves as the sensor output wiring line D.

The sensor scan circuit 6 includes scan shift register stages 12S, 34S, 56S . . . that are vertically connected to each other in this order, scan shift register stages 12W, 34W, 56W . . . that are vertically connected to each other in this order, analog switches AS12, AS34, AS56 . . . , analog switches AW12, AW34, AW56 . . . , a clock wiring line RCK, a reset clock wiring line RS, and a read-out clock wiring line RW. The start pulse RSSP is input into the shift register stage 12S, and the start pulse RWSP is input into the shift register stage 12W.

The reset wiring lines RS(i) and RS(i+1) of the pair of pixel rows made of the (i)-th row and the (i+1)-th row are connected to the reset clock wiring line RS through the analog switch AS(i)(i+1). The analog switch AS (i)(i+1) is turned ON and OFF by the output SRO(i) of the shift register stage (i)(i+1)S. The shift register stage (i)(i+1)S is operated based on the clock signal supplied by the clock wiring line RCK.

The read-out wiring lines RW(i) and RW(i+1) of the pair of pixel rows made of the (i)-th row and the (i+1)-th row are connected to the read-out clock wiring line RW through the analog switch AW(i)(i+1). The analog switch AW(i)(i+1) is turned ON and OFF by the output SRO(i)′ of the shift register stage (i)(i+1)S. The shift register stage (i)(i+1)W is operated based on the clock signal supplied by the clock wiring line RCK.

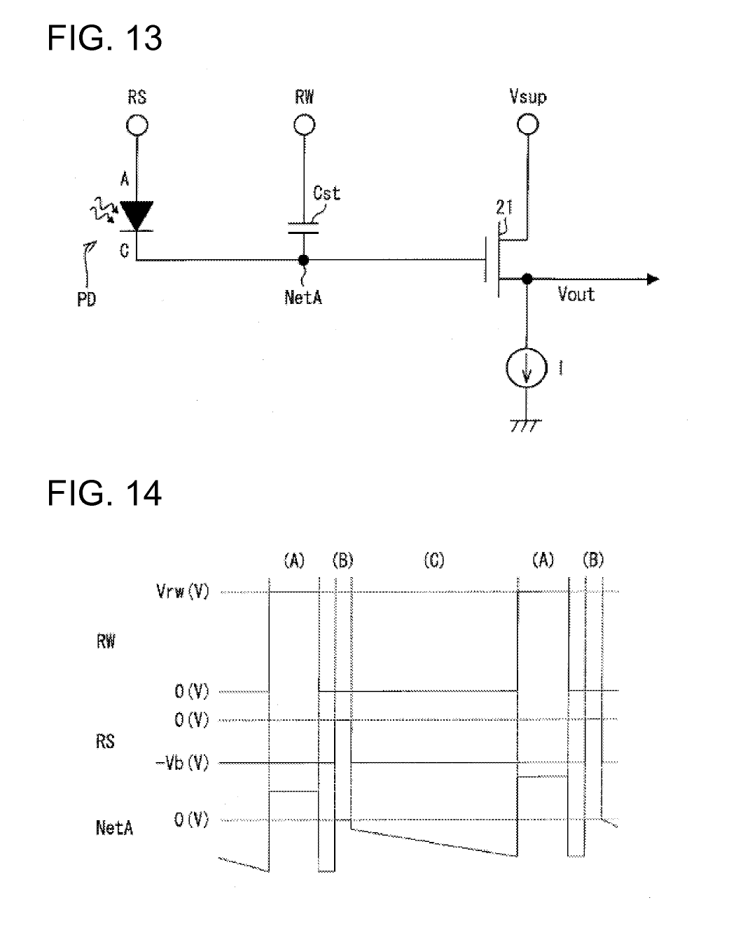

FIG. 13 shows a detailed configuration of a single photo sensor circuit. FIG. 14 shows a basic operation of the photo sensor circuit.

As shown in FIG. 13, a single clock pulse is input into the anode of the photo sensor PD as a reset pulse from the reset clock wiring line RS through the analog switch AS(i)(i+1) and the reset wiring line RS(i). This reset pulse is a pulse raised to 0(V) from −Vb(V) during a reset period (B) as shown in FIG. 14. This causes a current to flow through the photo sensor PD in the forward direction, and as shown in FIG. 14, the node NetA is thereby reset to 0(V). When the reset period (B) is completed, and the reset pulse drops to −Vb(V), a sensing period (C) starts as shown in FIG. 14. In the sensing period (C), the photo sensor PD is applied with a reverse bias voltage, and the potential of the node NetA gradually decreases due to effects of a leak current that is generated in the photo sensor PD. The size of this potential drop is varied in accordance with the intensity of light radiated to the photo sensor PD.

When the prescribed sensing period (C) has passed, as shown in FIG. 14, a read-out period (A) starts. As shown in FIG. 13, in the read-out period (A), a single clock pulse is input into the other end of the storage capacitance Cst as a read-out control pulse from the read-out clock wiring line RW through the analog switch AW(i)(i+1) and the read-out wiring line RW(i). As shown in FIG. 14, this read-out control pulse is a pulse that is raised from 0(V) to Vrw(V) during the read-out period (A). This causes the potential VnetA of the node NetA to increase by an amount represented by the following formula, where Ctotal represents the total capacitance connected to the node NetA, and RWp-p represents the amplitude of the read-out control pulse (Vrw, in this case):

(Cst/Ctotal)×RWp-p.

In the read-out period (A), as described above, the potential of the node NetA is pulled up, thereby turning on the TFT 21 that was in the OFF state during the reset period (B) and the sensing period (C). As shown in FIG. 13, the drain of the TFT 21 is applied with the power supply voltage Vsup through the data signal line GSL(j), which is used as a power supply wiring line, and the source of the TFT 21 is connected to the fixed current source I that is connected inside the IC. Therefore, the source output voltage Vout of the TFT 21 in the ON state can be represented by the following formula, where Vth represents the threshold voltage of the TFT 21, I represents the current of the fixed current source I, and β represents the conductance of the TFT 21:

Vout≈VnetA−Vth−(2I/β)^{1/2}.

This source output voltage Vout is read out by the source driver 4 through the data signal line RSL(j), which is used as a sensor output wiring line.

A cycle of the reset period (B), the sensing period (C), and the read-out period (A) described above is performed repeatedly.

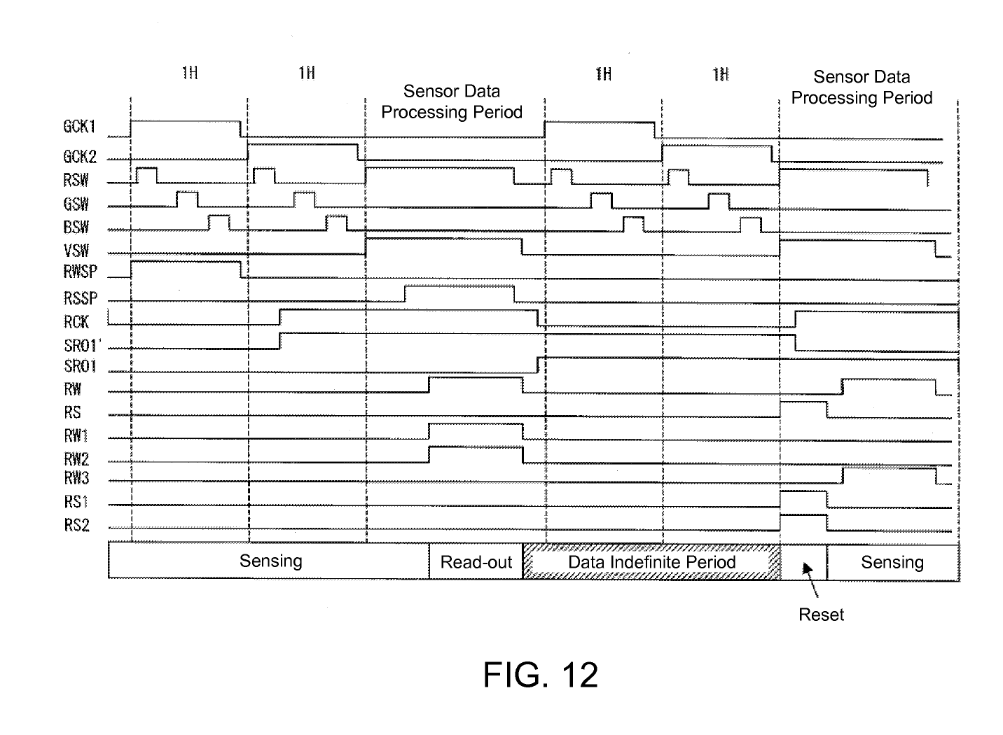

A timing chart in FIG. 12 shows an example of timing of the respective signals in the configuration shown in FIG. 11 together with the timing of the respective signals of the gate scan circuit 5. The example of FIG. 12 shows a process of SSD (Source Shared Driving) in which, during 1H of display (one horizontal period) that is defined by each gate clock GCK1, GCK2 . . . , the data signals are supplied to the data signal lines RSL(j), the data signal lines GSL(j), and the data signal lines BSL(j) of the respective display pixels in the same row in a time shared manner. A sensing operation by the photo sensor circuits is mostly performed during this display select period, and during a sensor data processing period that is different from the display select period, read-out and reset operations are performed by activating the control signal VSW so as to turn on a switch that connects the data signal line GSL(j) to the operating power supply of the photo sensor circuits. The reset signal RS(i) is output only during a period that is one frame period prior to the read-out operation performed by the corresponding read-out signal RW(i), for example.

Thus, by the sensor scan circuit 6, outputs of detection signals from all of the photo detection circuits senS and dark current detection circuits senD that are included in the same pair of pixel rows can be obtained simultaneously through different sensor output wiring lines. This allows a unit that detects the light intensity such as the source driver 4 to compensate the output of the detection signals of the photo detection circuits senS with the output of the detection signals of the dark current detection circuits senD that were obtained at the same time.

As described above, according to the present embodiment, by driving the pixel rows 31 in the respective pairs of pixel rows at once, and by reading out the detection outputs of the photo sensor circuits from these pixel rows at once, a plurality of pieces of data with smaller variations caused by the time lag between the respective pixel rows 31 can be obtained. Further, by averaging the detection output that were read out simultaneously from a plurality of photo sensor circuits having the mutually same configuration, data with even smaller variations can be obtained.

By mutually combining the plurality of pieces of data that were obtained in the manner described above, it makes possible an accurate correction of one piece of data with the other piece of data, which includes an accurate compensation of the photo detection results with the dark current detection results.

In the manner described above, it becomes possible to provide a display device equipped with photo sensor circuits capable of accurately correcting the photo detection results, which includes the accurate compensation for the photo detection, by combining different types of data.

Although the example in which one photo sensor circuit is provided for each display pixel made of three picture elements of RGB has been described above, the present invention is not limited to such, and the ratio thereof may be appropriately selected, and one photo sensor circuit may be provided for one display pixel or for other appropriate numbers of display pixels.

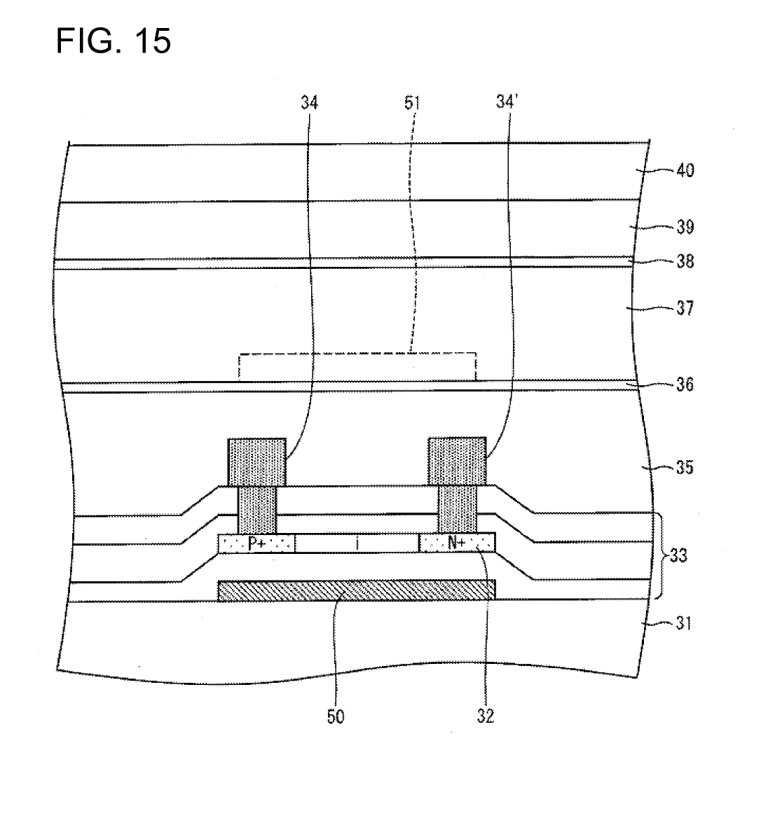

FIG. 15 shows a cross-sectional view of a panel including a device configuration of the photo sensor PD. The photo sensor PD is made of a pin photodiode in this case.

On a transparent substrate 31 that becomes a TFT substrate, a light-shielding film 50, a semiconductor layer 32, an insulating film 33, metal wiring lines 34 and 34′, a planarizing film 35, a transparent electrode 36, a liquid crystal layer 37, a transparent electrode 38, a color filter 39, and an opposite substrate 40 are laminated in this order. The semiconductor layer 32 that constitutes a pin photodiode has a P⁺ region, an “i” region, and an N⁺ region that are made of Si. The metal wiring line 34 as the anode electrode makes contact with the P⁺ region through a contact hole formed in the insulating film 33, and the metal wiring line 34′ as the cathode electrode makes contact with the N⁺ region through a contact hole formed in the insulating film 33.

In the dark current detection circuit senD, a light-shielding film 51 that blocks light for detecting the dark current of the pin photodiode is disposed on the transparent electrode 36. The light-shielding film 51 corresponds to the above-mentioned light-shielding film BM. A difference in the configuration between the dark current detection circuit senD and the photo detection circuit senS is presence or absence of this light-shielding film 51. The light-shielding film 51 may be disposed on the transparent electrode alone, on the side of the opposite substrate alone, or both on the transparent electrode and on the side of the opposite substrate.

Next, an embodiment that was developed from the example above will be explained.

FIG. 1 shows another example of an arrangement of photo sensor circuits in the display/sensor area 2a.

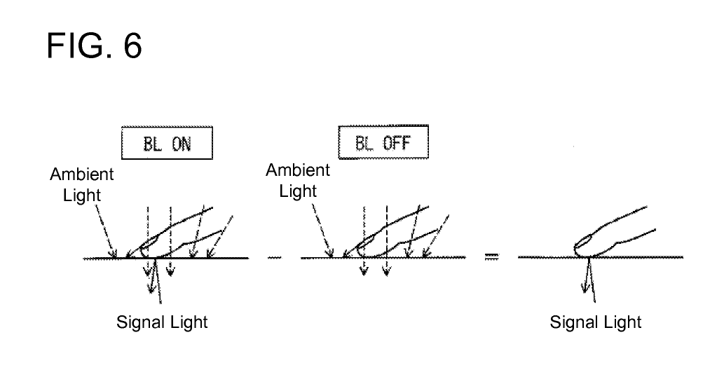

As the photo sensor circuits, four types of circuits are provided: the photo detection circuits senS that perform detection and output for illumination light; the dark current detection circuits senD that perform detection and output for dark currents; signal light detection circuits senON that perform detection and output for signal light; and signal noise light detection circuits senOFF. This configuration is used to accurately detect the intensity of internal signal light (signal light) of the device that is to be recognized by the liquid crystal display device 1 in a state in which ambient light can be radiated to the liquid crystal display device 1 as shown in FIG. 6.

In FIG. 6, for example, the photo sensor circuits detect signal light that is emitted to the panel surface from an infrared (IR) backlight and that is reflected at a touch position, thereby detecting a user's finger or the like touching the display panel 2. Here, external light radiated to the device becomes noise as ambient light. In order to detect the signal light, the signal light detection circuits senON and the signal noise light detection circuits senOFF are provided with a visible light filter that blocks visible light and that transmits infrared light as the color filter 39 shown in FIG. 15. Because the infrared light that transmits the color filter 39 includes infrared light of ambient light, which becomes noise to the internal signal light, the received light intensity when no signal light is radiated is detected by the signal noise light detection circuits senOFF, thereby correcting the detection results of the signal light detection circuits senON that detect the received light intensity upon signal light radiation. The signal light detection circuits senON detect a photo current (IR-dependent ambient light+signal light)+a dark current of the photo sensor PD, and the signal noise light detection circuits senOFF detect a photo current (IR-dependent ambient light)+a dark current of the photo sensor PD.

As described above, the present embodiment is configured such that, by using the photo detection circuits senS and the dark current detection circuits senD, the detection results of the photo detection circuits senS are compensated by the temperature-dependent dark current, thereby cancelling effects of temperature in the ambient light detection operation. Also, by using the signal light detection circuits senON and the signal noise light detection circuits senOFF, the intensity of signal light is detected as follows: (detection results of the signal light detection circuits senON)−(detection results of the signal noise light detection circuits senOFF).

In FIG. 1, rows of the picture elements and rows in which the photo sensor circuits are provided are distinguished, and the picture element rows are represented as LP(i), and the sensor rows, which are the rows having the photo sensor circuits, are represented by LS(k), where “i” and “k” are integers of 1 or greater that represent the row numbers, respectively. In FIG. 1, the picture element rows and the sensor rows are alternately arranged one by one, and the picture element row LP(i) and the sensor row LS(k) are adjacent to each other when “i” equals “k.”

In this figure, one display pixel PIX is made of an R picture element PIXR, a G picture element PIXG, and a B picture element PIXB as an example. The column of the display pixel PIX is represented by C(j), using “j” as the column number, and the column number of the picture element column is represented by “h,” where “j” and “k” are integers of 1 or greater.

In FIG. 1, the photo sensor circuits of four different consecutive sensor rows such as “k”=1 to 4, 5 to 8 . . . are driven and read out at once, respectively. In the four different consecutive sensor rows, a photo detection circuit senS, a dark current detection circuit senD, a signal light detection circuit senON, and a signal noise light detection circuit senOFF, which are respectively provided in different sensor rows, form a single block BL1. Here, the block BL1 that includes the photo detection circuit senS provided in the sensor row LP (k), the dark current detection circuit senD provided in the sensor row LP (k+1), the signal light detection circuit senON provided in the sensor row LP (k+2), and the signal noise light detection circuit senOFF provided in the sensor row LP (k+3) and the block BL1 that includes the photo detection circuit senS provided in the sensor row LP (k+2), the dark current detection circuit senD provided in the sensor row LP (k+3), the signal light detection circuit senON provided in the sensor row LP (k), and the signal noise light detection circuit senOFF provided in the sensor row LP (k+1) are alternately arranged in the row direction.

Also, in each block BL1, the photo sensor circuits disposed in the sensor rows LP (k) and LP (k+1) occupy an area with the column numbers of (h) to (h+5), and the photo sensor circuits disposed in the sensor rows LP (k+2) and LP (k+3) occupy an area with the column numbers of (h+3) to (h+8). The photo sensor circuit disposed in the sensor row LP (k) and the photo sensor circuit disposed in the sensor row LP (k+1) share the data signal line SL(h+1) as the power supply wiring line for the output amplifiers of the respective photo sensor circuits. The photo sensor circuit disposed in the sensor row LP (k+2) and the photo sensor circuit disposed in the sensor row LP (k+3) share the data signal line SL(h+4) as the power supply wiring line for the output amplifiers of the respective photo sensor circuits. These power supply wiring lines are connected to the power supply voltage Vsup through the switches SW1. The switches SW1 are turned ON and OFF by a control signal VSW, and are controlled to be ON during a prescribed period of time when the photo sensor circuits are driven. Connecting the power supply wiring lines to the power supply voltage Vsup through the switches SW1 is a conceptual example, and the power supply wiring lines may be provided with the same voltage as Vsup as a data signal, or the switches SW1 may be provided in the respective ends of the data signal lines.

The photo sensor circuit provided in the sensor row LP (k) uses the data signal line SL(h) as the sensor output wiring line (output wiring line). The photo sensor circuit provided in the sensor row LP (k+1) uses the data signal line SL(h+2) as the sensor output wiring line (output wiring line). The photo sensor circuit provided in the sensor row LP (k+2) uses the data signal line SL(h+3) as the sensor output wiring line (output wiring line). The photo sensor circuit provided in the sensor row LP (k+3) uses the data signal line SL(h+5) as the sensor output wiring line (output wiring line). In FIG. 1, in the respective areas of the photo sensor circuits, the start points of the arrows represent the power supply points from the shared power supply wiring lines, respectively, and the ends of the arrows represent the output points at which the results of the sensing operations that use the corresponding power supply are output to the output wiring lines, respectively.

As shown in the sensor rows such as LS3, LS4, LS7, LS8 . . . , when areas not included in the block BL1 are present, these areas may be used as dummy areas DAM, and may be provided with dummy circuit configurations so as to equalize the geometric, electrical, or optical boundary conditions among the blocks BL1.

The sensor scan circuit 6 includes the scan shift register stages SR1, SR2, SR3 . . . that are vertically connected to each other in this order, the analog switches AS1, AS2 . . . , the clock wiring lines CLK1 and CLK2, the reset clock wiring lines RST1 and RST2, and the read-out clock wiring line RWCK. Wiring lines for supplying operating clocks to the shift register stages SR1, SR2, SR3 . . . are not shown in the figure. The shift register stage SR1 is provided with the start pulse RWSP.

Of the sensor row LS(k) and the sensor row LS(k+1), one is connected to the clock wiring line CLK1 and the reset clock wiring line RST1, and the other is connected to the clock wiring line CLK2 and the reset clock wiring line RST2.

When “k”=1, 5, 9, 16 . . . , the read-out wiring lines RW(k) to RW(K+3) of the pairs of pixel rows made of the sensor rows LS(k) to LS(k+3) are connected to the read-out clock wiring line RWCK through the analog switch AS((k+3)/4). The analog switch AS((k+3)/4) is turned ON and OFF by the output SRO((k+3)/4) of the shift register stage SR((k+3)/4).

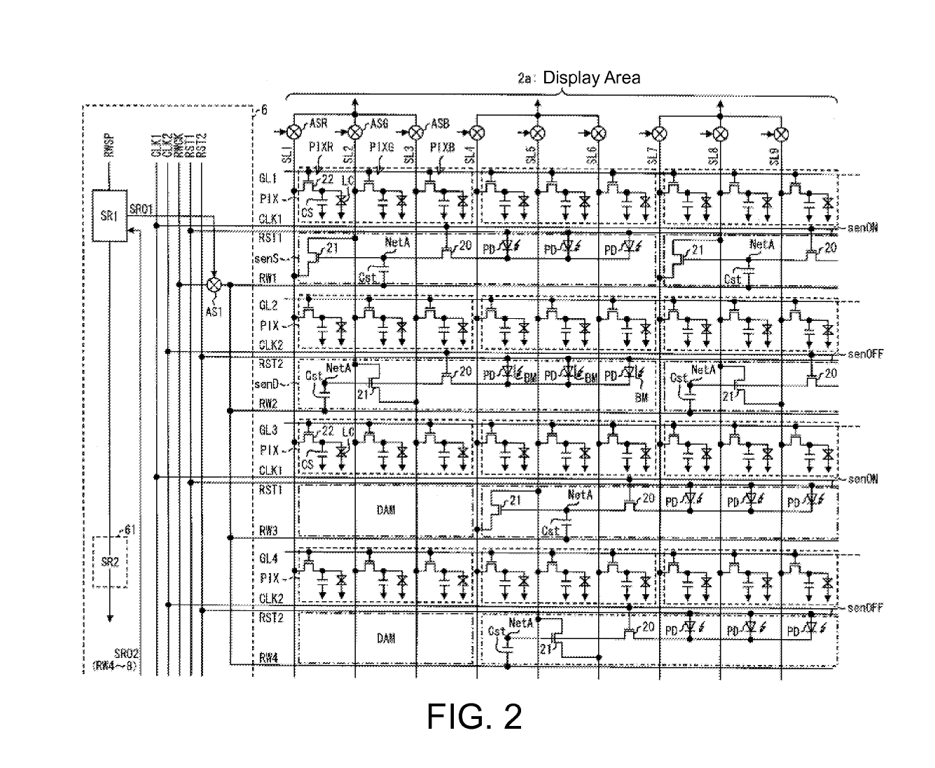

Next, FIG. 2 shows a detailed configuration of the display/sensor area 2a.

The respective RGB picture elements PIXR, PIXG, and PIXB that form the pixel PIX are arranged in this order, which is the order of the column numbers, and because they are similar to those of FIG. 11, the description thereof is omitted. In the respective same columns, R data signal lines, G data signal lines, and B data signal lines are connected to respective ones of output terminals of the source driver 4 through analog switches ASR, analog switches GSR, and analog switches BSR, respectively, thereby performing the SSD.

In the sensor row LS(k), each of the photo detection circuit senS and the signal light detection circuit senON is provided with a TFT (output amplifier) 21, a holding TFT (holding element) 20, three photo sensors PD, and a storage capacitance Cst. The TFT 21 and the holding TFT 20 are n-channel type, for example. The drain of the TFT 21 and the source of the TFT 21 are connected to the G data signal line and the R data signal line, respectively. The gate of the TFT 21 is connected to the node NetA, which is one end of the storage capacitance Cst. The gate of the holding TFT 20 is connected to the clock wiring line CLK1 when “k” is an odd number, and is connected to the clock wiring line CLK2 when “k” is an even number. One of the drain and source of the holding TFT 20 is connected to the node NetA.

The photo sensor PD is made of a photodiode here, for example. The anode of the photo sensor PD is connected to the reset wiring line RST1 when “k” is an odd number, and is connected to the reset wiring line RST2 when “k” is an even number. The cathode of the photo sensor PD is connected to one of the drain and source of the holding TFT 20. This way, the three photo sensors PD are connected to each other in parallel. The other end of the storage capacitance Cst is connected to the read-out wiring line RW(k).

The dark current detection circuit senD has the same configuration as those of the photo detection circuit senS and the signal light detection circuit senON described above, except that the respective photo sensors PD thereof are provided with light-shielding films BM.

When the photo detection circuit senS is configured to occupy an area from the (h)-th to the (h+5)-th picture element columns, the TFT 21 is disposed in an area between the data signal line SL(h) and the data signal line SL(h+1), the storage capacitance Cst is disposed in an area between the data signal line SL(h+1) and the data signal line SL(h+2), and the holding TFT 20 is disposed in an area between the data signal line SL(h+2) and the data signal line SL(h+3), respectively. The photo sensors PD are respectively disposed in an area between the data signal line SL(h+3) and the data signal line SL(h+4), an area between the data signal line SL(h+4) and the data signal line SL(h+5), and an area between the data signal line SL(h+5) and the data signal line SL(h+6) one by one.

In this case, the dark current detection circuit senD occupies an area from the (h)-th to the (h+5)-th picture element columns, and the storage capacitance Cst, the TFT 21, and the holding TFT 20 are respectively disposed in an area between the data signal line SL(h) and the data signal line SL(h+1), an area between the data signal line SL(h+1) and the data signal line SL(h+2), and an area between the data signal line SL(h+2) and the data signal line SL(h+3). The photo sensors PD are respectively disposed in an area between the data signal line SL(h+3) and the data signal line SL(h+4), an area between the data signal line SL(h+4) and the data signal line SL(h+5), and an area between the data signal line SL(h+5) and the data signal line SL(h+6) one by one.

In this case, when the signal light detection circuit senON is configured to occupy an area from the (h+3)-th to the (h+8)-th picture element columns, the TFT 21 is disposed in an area between the data signal line SL(h+3) and the data signal line SL(h+4), the storage capacitance Cst is disposed in an area between the data signal line SL(h+4) and the data signal line SL(h+5), and the holding TFT 20 is disposed in an area between the data signal line SL(h+5) and the data signal line SL(h+6), respectively. The photo sensors PD are respectively disposed in an area between the data signal line SL(h+6) and the data signal line SL(h+7), an area between the data signal line SL(h+7) and the data signal line SL(h+8), and an area between the data signal line SL(h+8) and the data signal line SL(h+9) one by one.

In this case, the signal noise light detection circuit senOFF occupies an area from the (h+3)-th to the (h+8)-th picture element columns, and the storage capacitance Cst, the TFT 21, and the holding TFT 20 are respectively disposed in an area between the data signal line SL(h+3) and the data signal line SL(h+4), an area between the data signal line SL(h+4) and the data signal line SL(h+5), and an area between the data signal line SL(h+5) and the data signal line SL(h+6). The photo sensors PD are respectively disposed in an area between the data signal line SL(h+6) and the data signal line SL(h+7), an area between the data signal line SL(h+7) and the data signal line SL(h+8), and an area between the data signal line SL(h+8) and the data signal line SL(h+9) one by one.

In the configuration described above, another arrangement pattern in which the photo detection circuit senS and the signal light detection circuit senON are replaced with each other, and the dark current detection circuit senD and the signal noise light detection circuit senOFF are replaced with each other is also possible.

With the above-mentioned arrangement, a relationship described below is satisfied, where the photo detection circuit senS is represented as a first photo sensor circuit and the dark current detection circuit senD is represented as a second photo sensor circuit, or the signal light detection circuit senON is represented as a first photo sensor circuit and the signal noise light detection circuit senOFF is represented as a second photo sensor circuit.

That is, the sensor output wiring lines, which are the output wiring lines to which the first photo sensor circuit and the second photo sensor circuit respectively output detection signals thereof, are data signal lines that are adjacent to the power supply wiring line shared by the first photo sensor circuit and the second photo sensor circuit from opposite sides. The output amplifier of the first photo sensor circuit is disposed between the power supply wiring line shared by the first photo sensor circuit and the second photo sensor circuit and the output wiring line to which the first photo sensor circuit outputs a detection signal thereof, and the output amplifier of the second photo sensor circuit is disposed between the power supply wiring line shared by the first photo sensor circuit and the second photo sensor circuit and the output wiring line to which the second photo sensor circuit outputs a detection signal thereof.

This way, in the first photo sensor circuits and the second photo sensor circuits that share the same power supply wiring line, the respective output amplifiers thereof are arranged at each side of the power supply wiring line alternately, which makes it possible to connect these circuits to each other in a simple manner.

A relationship described below is also satisfied.

That is, in a prescribed number of sensor rows, which is four, for example, a plurality, which is two, of pairs of the first photo sensor circuits and the second photo sensor circuits are provided, and each pair forms a sensor unit. The two pairs that respectively correspond to the power supply wiring lines that are adjacent to each other are provided in mutually different sensor rows. The power supply wiring line and the two output wiring lines that are allocated for one of the two pairs are the data signal lines that do not have therebetween the output amplifiers of the sensor rows in which the other of the two pairs is disposed. This corresponds to the configuration in the above-mentioned example in which, of the three data signal lines SL(h+3), SL(h+4), and SL(h+5) of the pair of the first photo sensor circuit and the second photo sensor circuit that respectively occupy areas from the (h+3)-th to the (h+8)-th picture element columns, any two lines do not have therebetween the output amplifiers (TFTs 21) of the pair of the first photo sensor circuit and the second photo sensor circuit that respectively occupy areas from the (h)-th to the (h+5)-th picture element columns.

This makes it possible to arrange the output amplifiers and the power supply wiring lines of the plurality of pairs of the first photo sensor circuits and the second photo sensor circuits so as not to interfere with each other.

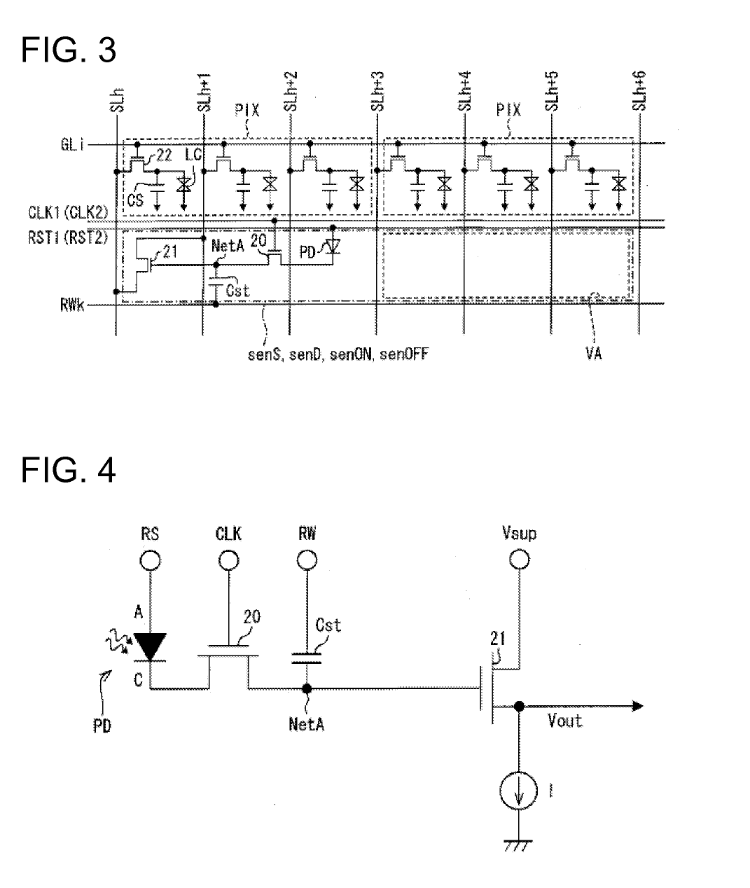

As shown in FIG. 3, by reducing the number of photo sensors PD and the like, the photo sensor circuits may also be configured to have a vacant area VA that is not occupied by the circuit area.

In the photo sensor circuits shown in FIG. 2, the holding TFTs 20 are provided. As shown in FIG. 4, with the holding TFTs 20, an operation similar to that of the circuit of FIG. 13 can be performed only when the holding TFT 20 is turned ON by the clock signal CLK input from the clock wiring line CLK1 or CLK2. Also, with the holding TFTs 20, it becomes possible to keep and hold the sensing results of the photo sensors PD in the node NetA. This way, when a plurality of pairs of the first photo sensor circuits and the second photo sensor circuits are provided in a prescribed number of sensor rows, the sensing operations by the photo sensors PD in the respective pairs can be performed sequentially, and the sensing results that are held in the nodes NetA can be read out at once at the end as detection results of the prescribed number of the sensor rows.

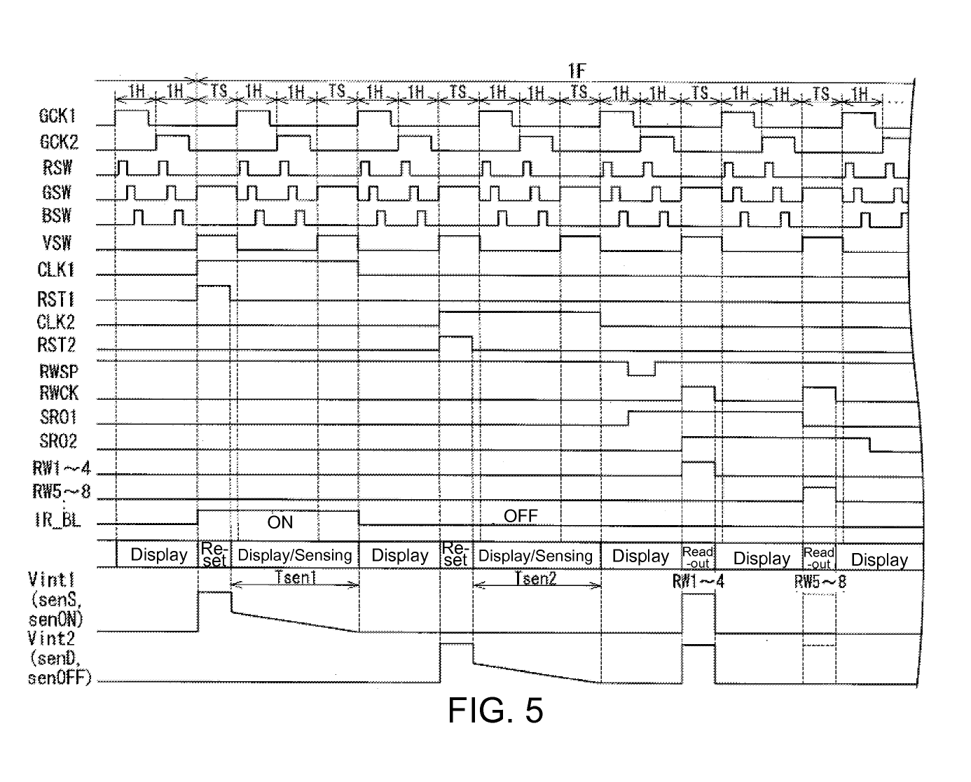

Next, FIG. 5 shows a timing chart for illustrating an operation of the photo sensor circuits of FIG. 2.

The gate scan circuit 5 is provided with gate clock signals GCK1 and GCK2 as operating clocks that have mutually different active periods. Each active period of the gate clock signals GCK1 and GCK2 defines a single horizontal period (1H). During 1H, a control signal RSW for R, a control signal GSW for G, and a control signal BSW for B that respectively instruct the analog switches ASR, ASG, and ASB to be turned ON and OFF for performing the SSD are sequentially activated in time-series manner.

In this operation, a sensor driving period TS in which the scanning pulse is not output from the gate scan circuit 5 is provided every 2H as an example. The period in which a scanning pulse is not output from the gate scan circuit 5 can be provided by disposing shift register stages that are not connected to the gate lines at prescribed intervals and the like in a gate driver configured in a typical manner, for example, so as to have horizontal periods in which a scanning pulse is not output. In other periods than the sensor driving period TS, a writing operation of the display data to the picture elements and the sensing operation of the photo sensor circuits can be performed, and during the sensor driving period TS, the display operation by the display data written in the picture elements and the reset operation, the sensing operation, and the output operation of the photo sensor circuits can be performed.

The sensor driving period TS can be appropriately set, and when 1H=12 ρs, it is set to be 14 μs, for example. The length of the sensor driving period TS can be set to an appropriate length such as the length corresponding to each horizontal period or the length corresponding to the horizontal blanking interval. The interval to insert the sensor driving period TS is not limited to 2H, and can be appropriately set. During the sensor driving period TS, the control signal VSW for connecting the power supply wiring lines of the photo sensor circuits to the power supply voltage Vsup is activated. By activating the control signal VSW, not only the power supply voltage is supplied to the TFTs 21 during the period in which the sensing results are read out, but also the power supply wiring lines of the photo sensor circuits are provided with the power supply voltage Vsup at the start of the sensing operation of the photo sensor circuits, at the end of the sensing operation, and upon reading out the sensing results of the photo sensor circuits, thereby preventing noise that is dependent on the display image from entering through the data signal lines. It is also possible to discharge the data signal lines by using an external IC or the like so as to fix the data signal lines to a fixed potential at the start of the sensor driving period TS. In this case, all of the data signal lines except for the power supply wiring lines for the photo sensor circuits are fixed to the fixed potential during the sensor driving period TS, and therefore, the noise contamination from other data signal lines than the power supply wiring lines can also be prevented.

During 1F period, an ON period of an infrared backlight (IR BL) and an OFF period thereof occur in this order one time each. During the ON period of the infrared backlight, the clock signal CLK1 is activated, and with the input of the reset pulse from the reset clock wiring line RST1, the sensing operation of the photo detection circuit senS and the signal light detection circuit senON is performed during a period Tsen1. The change of the potential of the node NetA during this period is indicated by Vint1. When the clock signal CLK1 becomes non-active, the sensing result is held in the node NetA. Next, during the OFF period of the infrared backlight, the clock signal CLK2 is activated, and with the input of the reset pulse from the reset clock wiring line RST2, the sensing operation of the dark current detection circuit senD and the signal noise light detection circuit senOFF is performed during a period Tsen2. The change of the potential of the node NetA during this period is indicated by Vint1. When the clock signal CLK1 becomes non-active, the sensing result is held in the node NetA. These respective sensing periods can be set appropriately. The infrared backlight is turned ON during the period Tsen1, but because it does not affect the visible light display, the period Tsen1 and the image display period can occur at the same time.

Next, the read-out start pulse RWSP is input into the shift register stage SR1, and during a period in which respective outputs of the shift register stages SR1, SR2 . . . are activated, the read-out control pulses RW1 to RW4, RW5 to RW8 . . . are sequentially activated, thereby reading out the detection results of the respective photo sensor circuits.

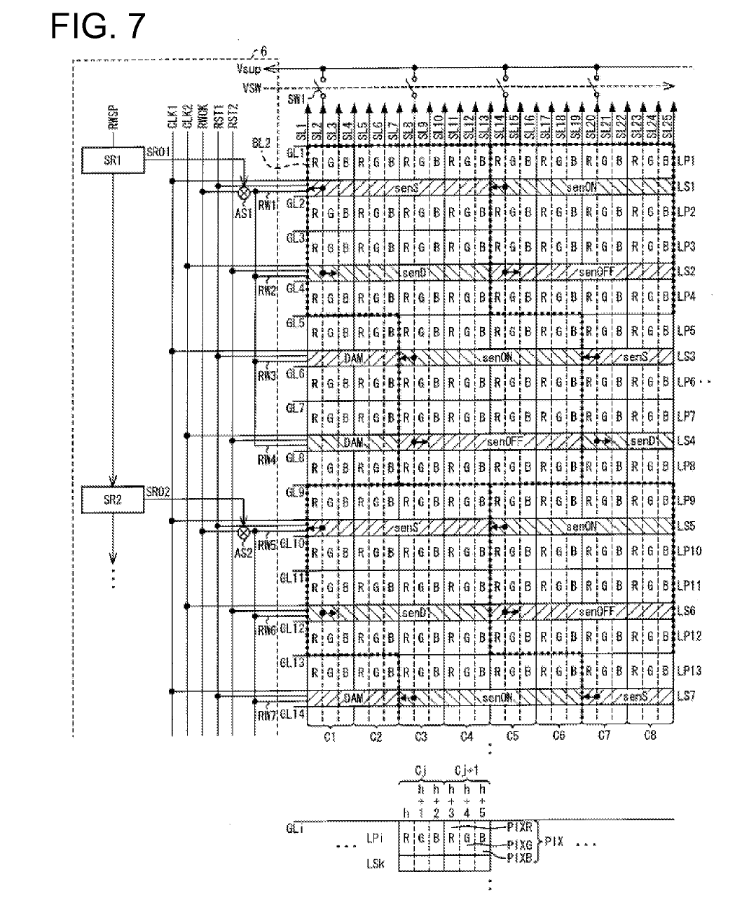

Next, FIG. 7 shows yet another arrangement example of the photo sensor circuits in the display/sensor area 2a.

In FIG. 7, when “i” is an odd number, the sensor row LS(k) is disposed between the picture element row LP(i) and the picture element row (i+1), that is, “k”=(i+1)/2. A block BL2 is configured so as to include one photo detection circuit senS, one dark current detection circuit senD, one signal light detection circuit senON, and one signal noise light detection circuit senOFF, which are included in four sensor rows, respectively. The photo detection circuit senS and the dark current detection circuit senD share a power supply wiring line, and the signal light detection circuit senON and the signal noise light detection circuit senOFF share a signal wiring line.

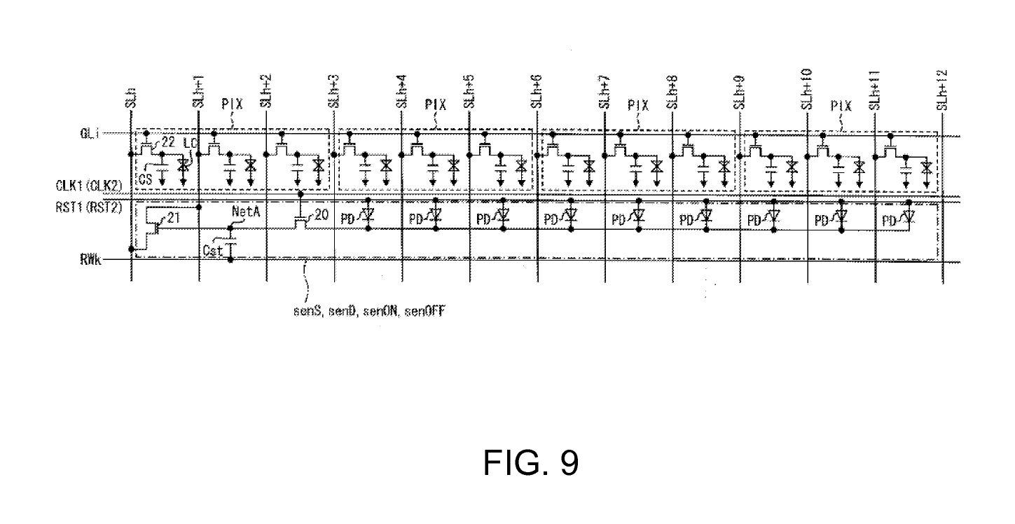

When the photo detection circuit senS is represented as a first photo sensor circuit, and the dark current detection circuit senD is represented as a second photo sensor circuit, and when the signal light detection circuit senON is represented as a first photo sensor circuit, and the signal noise light detection circuit senOFF is represented as a second photo sensor circuit, one of the two pairs of the first photo sensor circuits and the second photo sensor circuits respectively sharing the same power supply wiring lines occupies an area from the (h)-th to the (h+12)-th picture element columns, and the other pair occupies an area from the (h+7)-th to the (h+19)-th picture element columns. The detailed configuration example of each photo sensor circuit is shown in FIG. 9. This configuration is the same as that of the photo sensor circuit in FIG. 2, except that the nine photo sensors PD are connected to each other in parallel. Each of the photo sensors PD is disposed in an area sandwiched by two adjacent data signal lines.

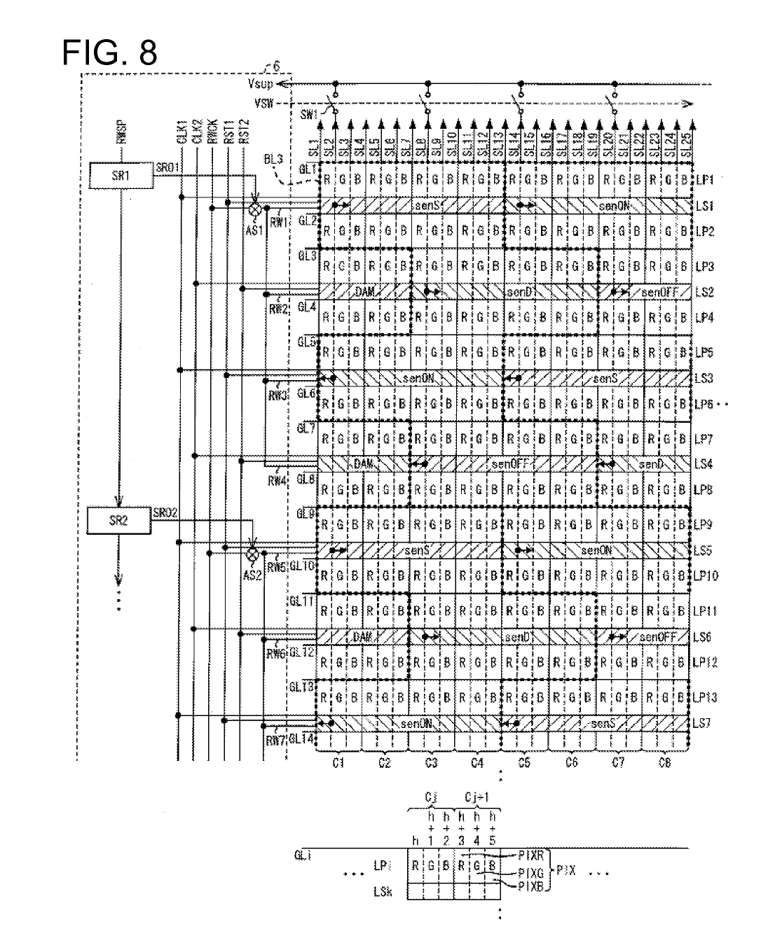

Next, FIG. 8 shows yet another arrangement example of the photo sensor circuits in the display/sensor area 2a.

In FIG. 8, when “i” is an odd number, the sensor row LS(k) is disposed between the picture element row LP(i) and the picture element row (i+1), that is, “k”=(i+1)/2. A block BL3 is configured so as to include one photo detection circuit senS, one dark current detection circuit senD, one signal light detection circuit senON, and one signal noise light detection circuit senOFF, which are included in four sensor rows, respectively. The photo detection circuit senS and the signal light detection circuit senON share a power supply wiring line, and the dark current detection circuit senD and the signal noise light detection circuit senOFF share a signal wiring line.

When the photo detection circuit senS is represented as a first photo sensor circuit, and the signal light detection circuit senON is represented as a second photo sensor circuit, and when the dark current detection circuit senD is represented as a first photo sensor circuit, and the signal noise light detection circuit senOFF is represented as a second photo sensor circuit, one of the two pairs of the first photo sensor circuits and the second photo sensor circuits respectively sharing the same power supply wiring lines occupies an area from the (h)-th to the (h+12)-th picture element columns, and the other pair occupies an area from the (h+7)-th to the (h+19)-th picture element columns. The detailed configuration example of each photo sensor circuit is shown in FIG. 9.

In FIGS. 1, 7, and 8, two photo sensor circuits out of the photo detection circuit senS, the dark current detection circuit senD, the signal light detection circuit senON, and the signal noise light detection circuit senOFF, which are included in four sensor rows, can be selected as the first photo sensor circuits, and the other two photo sensor circuits can be selected as the second photo sensor circuits, and a pair of circuits that share the same power supply wiring line may be formed by appropriately combining the first photo sensor circuit and the second photo sensor circuit. In FIGS. 7 and 8, the vacant area VA may also be provided in a manner similar to FIG. 3.

In the cases of FIGS. 1, 7, and 8, by the same principle as that of FIG. 11, outputs of detection signals of all of the photo detection circuits senS, the dark current detection circuits senD, the signal light detection circuits senON, and the signal noise light detection circuits senOFF, which are included in a prescribed number, i.e., four, of sensor rows, can be obtained by the sensor scan circuit 6 at once through different sensor output wiring lines. This allows a unit that detects the light intensity such as the source driver 4 to compensate the outputs of the detection signals of the photo detection circuits senS and the signal light detection circuits senON with the outputs of the detection signals of the dark current detection circuits senD and the signal noise light detection circuits senOFF, which were obtained at the same time.

As described above, according to the present embodiment, by driving the respective sensor rows in the prescribed number of pairs of sensor rows at once, and by reading out the detection outputs of the photo sensor circuits from these sensor rows at once, a plurality of pieces of data that have smaller variations caused by the time lag among the respective sensor rows can be obtained. Further, by averaging the detection outputs that were simultaneously read out from the plurality of photo sensor circuits having the mutually same configuration, data with even smaller variations can be obtained.

By mutually combining the plurality of pieces of data obtained in the manner described above, it becomes possible to accurately correct one piece of data with the other piece of data, which includes an accurate compensation of the photo detection results with the dark current detection results.

In the manner described above, it becomes possible to provide a display device equipped with photo sensor circuits capable of accurately correcting the photo detection results, which includes an accurate compensation for the photo detection, by combining the different types of data.

Because the photo sensor circuits in at least two different rows of the above-mentioned sensor rows share the same power supply wiring line, the number of wiring lines can be reduced, resulting in an effect of an efficient allocation of the display area to the picture elements and the photo sensor circuits. Further, by sharing the power supply wiring lines, the output amplifiers in the photo sensor circuits can be arranged such that the output amplifiers of the photo sensor circuits that share the same power supply wiring line are located in proximity of the power supply wiring line in a concentrated manner. This makes it easier to avoid the interference in placing the power supply wiring lines for the plurality of pairs of photo sensor circuits that share the same power supply wiring line, allowing for a significant increase in the number of sensor rows having the photo sensor circuits that can be read out at once. In the circuit arrangement shown in FIGS. 10 and 11, unlike the configuration described above, the power supply wiring lines are not shared, and therefore, the locations of the output amplifiers in the photo sensor circuits are distributed evenly in the display area, and the number of sensor rows having the photo sensor circuits that can be read out at once could not be increased beyond two. In contrast, in the present embodiment, the number of sensor rows having the photo sensor circuits that can be read out at once can be increased to four, which is twice as much as the conventional example. By utilizing the principle of the present embodiment, the number of sensor rows can further be increased.

The configuration of the photo sensor circuits is not limited to the above-mentioned example, and other appropriate configurations may also be employed such as using photo sensors PD made of diode-connection TFTs, using a plurality of photo sensors PD with series connection or with series-parallel connection, or disposing a plurality of storage capacitances Cst in the sensor circuit area in a dispersed manner. The output amplifier is not limited to a single element, and typically, an amplifier circuit made of a combination of a plurality of elements can be used. In the present embodiment, the source-follower type output amplifier (TFT 21) has been described as an example, but amplifiers with any output type may be employed. As the holding element, a switching element can be typically employed.

The type of the display device is not limited to a liquid crystal display device, and the present invention can be used for other display devices such as an EL display panel.

As described above, in order to solve the above-mentioned problem, a display device of the present invention includes: a display area in which a plurality of picture elements are arranged in a matrix; a plurality of sensor rows, output wiring lines, and power supply wiring lines in the display area, the plurality of sensor rows being provided with photo sensor circuits that output from respective output amplifiers detection signals in accordance with the intensity of illumination light, the output wiring lines receiving the detection signals, the power supply wiring lines supplying power to the output amplifiers; and a row driver that drives the respective photo sensor circuits, wherein the respective photo sensor circuits are driven by the row driver such that the detection signals of each group of a prescribed plural number of the sensor rows are output at once, wherein in the prescribed number of the sensor rows, the photo sensor circuit in at least two different sensor rows share the same power supply wiring line, and wherein the detection signals of the respective photo sensor circuits in the prescribed number of the sensor rows are output through the output wiring lines that are mutually different.

According to the above-mentioned invention, by the row driver, outputs of detection signals from all of the photo sensor circuits included in the prescribed number of the sensor rows can be obtained at once through different sensor output wiring lines. Therefore, in detecting light intensity, outputs of the photo sensor circuits can be compensated by output of detection signals that were simultaneously obtained from other photo sensor circuits.

As described above, according to the present invention, by driving the respective sensor rows in a prescribed number of pairs of sensor rows at once, and by reading out the detection outputs of the photo sensor circuits from these sensor rows at once, a plurality of pieces of data that have smaller variations caused by the time lag among the respective sensor rows can be obtained. Further, by averaging the detection outputs that were simultaneously read out from the plurality of photo sensor circuits having the same configuration, data with even smaller variations can be obtained.

By mutually combining the plurality of pieces of data obtained in the manner described above, it becomes possible to accurately correct one piece of data with the other piece of data, which includes an accurate compensation of the photo detection results with the dark current detection results.

As described above, it becomes possible to achieve an effect of providing a display device with photo sensor circuits capable of accurately correcting the photo detection results, which includes an accurate compensation for the photo detection, by combining the different types of data.

Because the photo sensor circuits in at least two different rows of the above-mentioned sensor rows share the same power supply wiring line, the number of wiring lines can be reduced, resulting in an effect of an efficient allocation of the display area to the picture elements and the photo sensor circuits. Further, by sharing the power supply wiring lines, the output amplifiers in the photo sensor circuits can be arranged such that the output amplifiers of the photo sensor circuits that share the same power supply wiring line are located in proximity of the power supply wiring line in a concentrated manner. This makes it easier to avoid the interference in placing the power supply wiring lines for the plurality of pairs of photo sensor circuits that share the same power supply wiring line, resulting in an effect of significantly increasing in the number of sensor rows having the photo sensor circuits that can be read out at once.

In order to solve the above-mentioned problem, in the display device according to the present invention, the output wiring lines and the power supply wiring lines are data signal lines that supply data signals to the picture elements.

According to the above-mentioned invention, because the data signal lines are used for the output wiring lines and the power supply wiring lines, the number of wiring lines can be reduced, resulting in an effect of efficient allocation of the display area to the picture elements and the sensor circuits.

In order to solve the above-mentioned problem, in the display device according to the present invention, the photo sensor circuits that share the same power supply wiring line in at least two different rows of the sensor rows includes two photo sensor circuits of a first photo sensor circuit and a second photo sensor circuit that are respectively disposed in the two mutually different sensor rows. The output wiring lines to which the first photo sensor circuit and the second photo sensor circuit respectively output the detection signals are the data signal lines that are respectively adjacent to the power supply wiring line shared by the first photo sensor circuit and the second photo sensor circuit from opposite sides. The output amplifier of the first photo sensor circuit is disposed between the power supply wiring line shared by the first photo sensor circuit and the second photo sensor circuit and the output wiring line to which the first photo sensor circuit outputs the detection signal. The output amplifier of the second photo sensor circuit is disposed between the power supply wiring line shared by the first photo sensor circuit and the second photo sensor circuit and the output wiring line to which the second photo sensor circuit outputs the detection signal.

According to the above-mentioned invention, in the first photo sensor circuit and the second photo sensor circuit that share the same power supply wiring line, the respective output amplifiers thereof are arranged at each side of the power supply wiring line alternately, which makes it possible to connect these circuits to each other in a simple manner.

In order to solve the above-mentioned problem, in the display device according to the present invention, the prescribed number of the sensor rows include a plurality of pairs of the first photo sensor circuits and the second photo sensor circuits, and the plurality of pairs include two of the pairs that are provided in the mutually different sensor rows and that respectively correspond to the power supply wiring lines adjacent to each other. The power supply wiring line and the two output wiring lines that are allocated for one of the two pairs are the data signal lines that do not have therebetween the output amplifiers of the sensor rows in which the other of the two pairs is provided.

According to the above-mentioned invention, even when a plurality of pairs of the first photo sensor circuits and the second photo sensor circuits are provided in the prescribed number of sensor rows, the output amplifiers and the power supply wiring lines can be arranged without interfering with each other between the plurality of pairs, resulting in an effect of reading out the detection results at once.

In order to solve the above-mentioned problem, in the display device according to the present invention, the plurality of pairs provided in the prescribed number of the sensor rows include two pairs of the first photo sensor circuits and the second photo sensor circuits, the first photo sensor circuits including two of a photo detection circuit that detects ambient light entering the device, a detection circuit that detects a dark current of the photo sensor, a detection circuit that detects internal signal light of the device, and a detection circuit that detects noise light to the internal signal light, the second photo sensor circuits including the other two circuits.

According to the above-mentioned invention, the detection results of the four photo sensor circuits can be obtained at once, and therefore, by compensating the detection result of the photo detection circuit for the ambient light with the temperature-dependent dark current using the photo detection circuit of the ambient light to the device and the detection circuit for the dark current of the photo sensor, the temperature compensation in the external light detection operation can be achieved. Also, by using the detection circuit that detects the internal signal light of the device and the detection circuit that detects the noise light to the internal signal light, the intensity of the internal signal light can be detected.

In order to solve the above-mentioned problem, the display device according to the present invention further includes holding elements in the first photo sensor circuit and the second photo sensor circuit, the holding elements holding detection results that correspond to the detection signals until the detection signals are output to the output wiring lines.

According to the above-mentioned invention, even when a plurality of pairs of the first photo sensor circuits and the second photo sensor circuits are included in the prescribed number of the sensor rows, detection results of detection operations that are performed for the respective pairs in a time-series manner can be held, and by collectively outputting detection signals to the output wiring lines, those detection results can be read out at once.

In order to solve the above-mentioned problem, in the display device of the present invention, one frame period includes a period in which display data is not written in the picture element, and during the period in which the display data is not written in the picture element, the power supply wiring line is connected to a power source of the output amplifier.

According to the above-mentioned invention, during the period in which the display data is not written in the picture elements, the data signal lines are not used for the writing operation, which allows the data signal lines to be used during a period in which the detection results of the photo sensor circuits are read out and during a period in which processes for the reset operation and the sensing operation of the photo sensor circuits are performed. During the period in which the detection results are read out, the power supply voltage for the output amplifiers can be supplied through the data signal lines. Also, at the start of the sensing operation of the photo sensor circuits, at the end of the sensing operation, and upon reading out the sensing results of the photo sensor circuits, by setting the power supply wiring line to the power supply voltage for the output amplifier, it becomes possible to prevent noise that is dependent on an display image from entering through the data signal lines.

The present invention is not limited to the above-mentioned embodiments, and various modifications can be made without departing from the scope defined by claims. That is, embodiments achieved by combining techniques that have been appropriately modified without departing from the scope defined by claims are also included in the technical scope of the present invention.

### INDUSTRIAL APPLICABILITY

The present invention is suitably used for a display device with a fingerprint recognition or a touch panel using photo sensors.

### DESCRIPTIONS OF REFERENCE CHARACTERS

1 liquid crystal display device (display device)

2a display/sensor area (display area)

6 sensor scan circuit (row driver)

20 holding TFT (holding element)

21 TFT (output amplifier)

LSk sensor row

PD photo sensor

senS photo detection circuit (photo sensor circuit, first photo sensor circuit)

senD dark current detection circuit (photo sensor circuit, first photo sensor circuit, second photo sensor circuit)

senON signal light detection circuit (photo sensor circuit, first photo sensor circuit, second photo sensor circuit)

senOFF signal noise light detection circuit (photo sensor circuit, second photo sensor circuit)

PIXR, PIXG, PIXB picture element

SL2, SL5, SLB, . . . data signal line (power supply wiring line)

SL1, SL3, SL4, SL6, . . . data signal line (output wiring line)

1. A display device, comprising:
a display area in which a plurality of picture element are arranged in a matrix;
a plurality of sensor rows, output wiring lines, and power supply wiring lines that are arranged in the display area, the plurality of sensor rows being provided with photo sensor circuits that respectively output detection signals in accordance with illumination light intensity from output amplifiers thereof, the output wiring lines receiving the detection signals outputted thereto, the power supply wiring lines supplying power to the output amplifiers; and
a row driver that drives the respective photo sensor circuits,
wherein the row driver drives the respective photo sensor circuits such that the detection signals are output at once for each group of prescribed plural number of the sensor rows,
wherein the prescribed number of the sensor rows include the photo sensor circuits in which the same power supply wiring line is shared by at least two different rows of the sensor rows, and
wherein the detection signals of the photo sensor circuits in the prescribed number of the sensor rows are output through the output wiring lines that are mutually different.

2. The display device according to claim 1, wherein the output wiring lines and the power supply wiring lines are data signal lines that supply data signals to the picture elements.

3. The display device according to claim 2, wherein the photo sensor circuits in which the same power supply wiring line is shared by at least two different rows of the sensor rows include two of the photo sensor circuits of a first photo sensor circuit and a second photo sensor circuit, the two photo sensor circuits being provided in the two mutually different sensor rows,
wherein the output wiring lines to which the first photo sensor circuit and the second photo sensor circuit respectively output the detection signals thereof are the data signal lines that are, at respective sides opposite to each other, adjacent to the power supply wiring line shared by the first photo sensor circuit and the second photo sensor circuit,
wherein the output amplifier of the first photo sensor circuit is disposed between the power supply wiring line shared by the first photo sensor circuit and the second photo sensor circuit and the output wiring line to which the first photo sensor circuit outputs the detection signal, and
wherein the output amplifier of the second photo sensor circuit is disposed between the power supply wiring line shared by the first photo sensor circuit and the second photo sensor circuit and the output wiring line to which the second photo sensor circuit outputs the detection signal.

4. The display device according to claim 3, wherein the prescribed number of the sensor rows include a plurality of pairs of the first photo sensor circuit and the second photo sensor circuit,
wherein the plurality of pairs include two of the pairs that are respectively disposed in the mutually different sensor rows and that correspond to the power supply wiring lines adjacent to each other, and
wherein the power supply wiring line and the two output wiring lines allocated for one of the two pairs are data signal lines that do not have therebetween the output amplifiers of the sensor rows in which the other of the two pairs is provided.

5. The display device according to claim 4, wherein the plurality of pairs provided in the prescribed number of the sensor rows include two of the pairs in which two of a photo detection circuit for ambient light to the device, a detection circuit for a dark current of the photo sensor, a detection circuit for internal signal light of the device, and a detection circuit for noise light to the internal signal light become the first photo sensor circuits, and the other two become the second photo sensor circuits.

6. The display device according to claim 4, further comprising holding elements in the first photo sensor circuit and the second photo sensor circuit, the holding element holding detection results that correspond to the detection signals until the detection signals are output to the output wiring lines.

7. The display device according to claim 2, wherein one frame period includes a period in which display data is not written in the picture elements, and
wherein, during the period in which display data is not written in the picture elements, the power supply wiring lines are connected to a power supply for the output amplifiers.
